(19) United States
(12) Patent Application Publication
(10) Pub. No.: US 2012/0090298 A1
(43) Pub. Date: Apr. 19, 2012

(54) ENGINE COMBUSTION CONDITION AND EMISSION CONTROLS

(76) Inventor: James M. Cleeves, Redwood City, CA (US)

(21) Appl. No.: 13/271,096

(22) Filed: Oct. 11, 2011

Related U.S. Application Data
(60) Provisional application No. 61/391,530, filed on Oct. 8, 2010.
(60) Provisional application No. 61/501,654, filed on Jun. 27, 2011.

(30) Foreign Application Priority Data
Oct. 8, 2011 (US) PCT/US2011/055505

(51) Int. Cl. F01N 3/24; B23P 17/00; B23P 17/04; F01N 3/00

(52) U.S. Cl. 60/274; 60/324; 60/299; 29/890.08; 29/890

(57) ABSTRACT

Features relating to engine efficiency and emissions controls are described. Systems, methods, articles or manufacture and the like can include features relating to integrated muffler and emissions controls for engine exhaust, water-injected internal combustion engine with an asymmetric compression and expansion ratio, controlled combustion durations for HCCI engines, piston shrouding of sleeve valves, low element count bearings, improved ports, and premixing of fuel and exhaust.

### CROSS-REFERENCE TO RELATED APPLICATION

This application claims priority under 35 U.S.C. §119(e) to U.S. provisional patent application Ser. No. 61/391,530 filed on Oct. 8, 2010 and entitled “Control of Internal Combustion Engine Combustion Conditions and Exhaust Emissions,” under 35 U.S.C. §119(e) to U.S. provisional patent application Ser. No. 61/501,654 filed on Jun. 27, 2011 and entitled “High Efficiency Internal Combustion Engine,” and under 35 U.S.C. §120 to Patent Cooperation Treaty Application No. PCT/US2011/055505 filed on Oct. 8, 2011 and entitled “Engine Combustion Condition and Emission Controls.”

The current application is also related to co-pending and co-owned international patent application no. PCT/US2011/027775 entitled “Multi-Mode High Efficiency Internal Combustion Engine” and also to co-pending and co-owned international patent application no. PCT/US2011/055457 entitled “Single Piston Sleeve Valve with Optional Variable Compression Ratio Capability.” The disclosure of each of the documents identified in this and the preceding paragraph is incorporated by reference herein in its entirety.

### TECHNICAL FIELD

The subject matter described herein relates generally to internal combustion engines and in particular to operation mode, combustion condition, and emissions control approaches that may provide improvements in efficiency and/or pollutant emission rates.

### BACKGROUND

Internal combustion engines are commonly used to provide power for motor vehicles as well as in other applications, such as for example for lawn mowers and other agricultural and landscaping equipment, power generators, pump motors, boats, planes, and the like. Currently available operation modes, physical features, and the like of such engines provide fuel efficiency, power output, and pollutant emission characteristics that are not advantageous in light of increasing concerns over resource scarcity and environmental degradation. Internal combustion engines can include, but are not limited to, conventional spark-ignited engines, direct or indirect injection diesel engines, and homogeneous charge compression ignition (HCCI) engines.

Conversion of fuel into mechanical energy in an internal combustion engine occurs via a series of small explosions or combustions. The types of internal combustion engines can differ in the way these small explosions or combustions occur. In a spark-ignited engine, fuel is mixed with air, delivered into a combustion chamber where it is compressed by action of a piston and ignited by sparks from spark plugs or other controlled ignition sources. In a diesel engine, inlet air is first compressed in the combustion chamber, and then the fuel is injected and ignited by the heating of the air that occurs due to its compression. In an HCCI engine, well-mixed fuel and oxidizer (typically air) are injected into the combustion chamber and compressed to the point of auto-ignition.

Efficiency at lower engine loads can be improved in some instances by increasing a compression ratio of the engine. The compression ratio is a measure of the degree to which an air-fuel mixture is compressed before ignition and is defined as the expanded volume of the engine combustion chamber divided by the compressed volume of the engine combustion chamber. A high compression ratio in a standard Otto cycle engine generally results in the piston performing a longer expansion in the power stroke, and consequently more work, in comparison to the same engine running at a lower compression ratio. Compression ratios of gasoline powered automobiles using gasoline with an octane rating of 87 typically range between about 8.5:1 and 10:1.

The maximum compression ratio achievable by an engine can be limited by uncontrolled advanced (i.e. prior to an intended timing) ignition of the air-fuel mixture at high temperatures, a problem commonly referred to as engine knock. Knock can occur as a result of disassociation of the fuel into more easily combustible molecular fragments when the mixture is exposed to high temperatures for a sufficiently long period of time. The high temperature exposure can result in these fragments initiating an uncontrolled explosion outside the envelope of the normal combustion. For example, auto-ignition typically occurs prior to the piston reaching the top dead center (TDC) position of a compression stroke, so in some cases knock can occur before the piston passes TDC and begins the expansion stroke. Auto-ignition can also occur on the expansion stroke as the end gas is heated and compressed by the already burned mixture so that pockets of the combustion mixture ignite outside of the normal combustion envelope. Engine knock causes audible and potentially damaging pressure waves inside combustion chamber. Knock is a specific problem associated with the more general issue of auto-ignition. In this document, auto-ignition refers to instances in a spark-ignited engine in which the ignition occurs independently of when the spark is fired, as in homogeneous ignition or a burn initiated by a surface ignition prior to the spark event. In a diesel or HCCI engine, each of which relies upon auto-ignition to commence combustion of the engine on each engine cycle, premature ignition due to excessive thermal pre-activation of the fuel or the air-fuel mixture can undesirably provide a similar effect of the fuel burning too quickly or igniting before the piston is properly positioned to most efficiently convert the released energy to useful mechanical work.

A variety of factors in addition to high compression ratios can affect the occurrence of knock in particular and auto-ignition or premature ignition in general. In a spark-ignited engine, low octane gasoline may spontaneously ignite at lower temperatures than high octane gasoline. Hot wall or piston temperatures in engines can also tend to increase the heating of the air-fuel mixture, thereby increasing a tendency of the fuel to auto-ignite, as can localized hot spots, such as around the exhaust valve, which may cause localized heating of the air-fuel mixture and knocking in the area of the hot spots. A fast burn rate of the fuel-air mixture, for example due to high turbulence, which promotes good mixing and rapid burning of the fuel, can reduce the likelihood of spontaneous ignition. However, high inlet flow field turbulence can also increase the temperature rise in the inlet air-fuel mixture, which increases the likelihood of spontaneous ignition. Increasing the quantity of fuel in the mixture up to a stoichiometric ratio (i.e. one at which precisely enough oxygen is provided to be completely consumed in full conversion of the fuel to fully oxidized end products (e.g. water and carbon dioxide) can increase the energy released and hence the pressure and temperature of the end gas, which can affect the tendency to knock. Advanced ignition timing can also generate high peak pressures and temperatures, thereby contributing to a tendency for auto-ignition under some conditions.

In motor vehicles and other applications, the exhaust gases from an internal combustion engine are generally passed through a muffler to reduce noise emissions and, because of modern day concerns about air pollutants, through a catalytic converter or other device that causes reactions of or otherwise reduces the concentrations of less desirable combustion by-products that are formed by the combustion of fossil fuels.

### SUMMARY

### Integrated Muffler and Emissions Control for Engine Exhaust.

In one aspect, a system includes a tubular conduit for conducting exhaust gases from an exhaust gas source. The tubular conduit includes a conduit cross sectional flow area approximately perpendicular to a direction of exhaust gas flow within the tubular conduit. A plurality of passages is positioned within and at least partially filling the conduit cross sectional flow area at a section of the tubular conduit. Each of the plurality of passages has a passage length and a passage cross sectional flow area, which are paired to create an approximately equal flow rate for exhaust gases flowing through each of the plurality of passages. A collector chamber positioned downstream of the plurality of passages receives the exhaust gases exiting the plurality of passages. The collector chamber has a sufficiently large collector chamber volume such that the exhaust gases within the collector volume present an approximately equivalent pressure across an exit face of each of the plurality of passages.

In an interrelated aspect, a method includes conducting exhaust gases from an exhaust gas source through a tubular conduit that includes a conduit cross sectional flow area approximately perpendicular to a direction of exhaust gas flow within the tubular conduit. The method also includes causing the exhaust gases to flow through a plurality of passages positioned within and at least partially filling the conduit cross sectional flow area at a section of the tubular conduit. Each of the plurality of passages has a passage length and a passage cross sectional flow area that are paired to create an approximately equal flow rate for the exhaust gases flowing through each of the plurality of passages. The exhaust gases are received in a collector chamber positioned downstream of the plurality of passages. The collector chamber has a sufficiently large collector chamber volume such that the exhaust gases within the collector volume present an approximately equivalent pressure across an exit face of each of the plurality of passages.

In another interrelated aspect, a method includes forming an array of passages that includes a plurality of passages having a distribution of cross sectional flow areas. Each passage of the plurality of passages has a passage length and a passage cross sectional flow area that are paired to create an approximately equal flow rate for exhaust gases flowing through each of the plurality of passages. The array of passages is positioned such that the array of passages at least partially fills a conduit cross sectional flow area of a tubular conduit for conducting exhaust gases from an exhaust gas source. A collector chamber is connected and positioned downstream of the array of passages to receive exhaust gases exiting the plurality of passages. The collector chamber has a sufficiently large collector chamber volume such that the exhaust gases within the collector volume present an approximately equivalent pressure across an exit face of each of the plurality of passages.

In some variations of the above-summarized aspects, one or more of the following features can optionally be included in any feasible combination. A plurality of second passages can optionally be positioned within a second section of the tubular conduit downstream of the collector chamber. Each of the plurality of second passages can have a second passage length and a second passage cross sectional flow area that are paired to create a second approximately equal flow rate for exhaust gases flowing through each of the second plurality of passages. At least part of an interior surface area of one or more of the plurality of passages can optionally include a catalyst coating. The catalyst coating can optionally catalyze at least one reaction that converts at least one combustion by-product present in the exhaust gases to at least one target compound. A surface roughening treatment that provides increased surface area relative to an untreated surface can be applied to at least part of the interior surfaces of one or more of the plurality of passages. The plurality of passages can optionally include a piece of sheet metal rolled to fit within the conduit cross sectional flow area. The piece of sheet metal can optionally include a plurality of corrugations of differing lengths that form the plurality of passages when the piece of sheet metal is rolled to fit within the conduit cross sectional flow area. The piece of sheet metal can optionally include an approximately triangular shape that includes a first edge, a second edge, and a third edge. An axis of each of the plurality of corrugations can optionally be aligned approximately parallel to the first edge. The piece of sheet metal can optionally be rolled along a rolling axis that is at least approximately perpendicular to the first edge.

Implementations of the current subject matter can provide one or more advantages. For example, integration of a muffler and catalytic converter into a single unit or device can result in size and weight savings that can be advantageous in small vehicles, such as motorcycles, scooters, or light duty automobiles.

Water-Injected Internal Combustion Engine with Asymmetric Compression and Expansion Ratio.

In one aspect, a method includes creating a combustion mixture that includes an amount of air, an amount of fuel, and an amount of water within a combustion volume of an internal combustion engine. The combustion mixture is compressed, for example by reducing the combustion volume by a compression ratio. The reducing of the combustion volume includes movement of a piston in a first direction. The combustion mixture is ignited and combusted to form an exhaust mixture that includes water vapor and other combustion products. The combusting generates a peak combustion temperature inside the combustion volume that is less than a pre-defined maximum peak temperature due to the amount of water. The combusting includes expanding the combustion volume by an expansion ratio. The expanding includes movement of the piston in a second direction opposite to the first direction. The exhaust mixture is exhausted from the combustion volume.

In some variations of the above-summarized aspects, one or more of the following features can optionally be included in any feasible combination. The amount of water can optionally be approximately two times or more the amount of fuel. The compression ratio can optionally approximately 10:1 or greater. The method can further include injecting an additional amount of water into the combustion volume after the igniting and before the exhausting. The additional amount of water can optionally in a range of approximately three to four times the amount of fuel. The injecting of the additional amount of water can optionally include increasing a pressure in the combustion volume to approximately 1400 psi or greater. The expansion ratio can optionally in a range of approximately 35:1. The method can optionally further include condensing liquid-phase water from the exhaust stream. The condensing can optionally include passing the exhaust through a condenser system that converts at least some of the water vapor in the exhaust stream to the liquid-phase. The combustion chamber can optionally include at least one interior surface. The at least one interior surface can optionally include comprising a catalyst coating. The catalyst coating can optionally include catalyst particles to promote more complete combustion of at least one of hydrocarbons and carbon monoxide during formation of the exhaust mixture. These coatings can optionally be combined with ceramic coatings that would further limit the amount of heat lost to the engine cooling. The pre-defined threshold temperature can optionally be below a NO_{X} formation temperature. The creating of the combustion mixture can optionally include delivering at least one of air and an air-fuel mixture to the combustion volume via an intake port controlled by an intake valve. The creating of the combustion mixture can optionally further include closing the intake valve and then injecting water directly into the combustion volume.

### Controlled Combustion Duration for HCCI Engines.

In one aspect, a system includes a flame front control feature located within a combustion chamber of an internal combustion engine. A desired ignition location is also located within the combustion chamber. The desired ignition location havihasng sufficient thermal energy to ignite a fuel-air mixture. The desired ignition location is located proximate to the flame front control feature within the combustion chamber such that igniting of a combustion mixture in the combustion chamber by the desired ignition location causes a flame front of the ignited combustion mixture to be directed along a preferred path within the combustion chamber with the flame front control feature to cause a desired combustion duration.

In an interrelated aspect, a method includes igniting a combustion mixture in a combustion chamber of a homogeneous charge compression ignition engine. The igniting includes causing ignition at a desired physical location proximate to a flame front control feature. A flame front of the ignited combustion mixture is directed along a preferred path within the combustion chamber. The directing includes guiding the flame front with the flame front control feature to cause a desired combustion duration.

In some variations of the above-summarized aspects, one or more of the following features can optionally be included in any feasible combination. A surface temperature of a piston crown can optionally be varied using a variable insulation layer on the surface to cause the igniting to occur at the desired physical location. The flame front control feature can optionally include a shoulder formed on a crown of a piston that guides the flame front around at least part of a circumference of the piston. The desired ignition location can optionally include a glow plug.

### Piston Shrouding of Sleeve Valves.

In one aspect, a system includes an intake port for delivering a fluid comprising air and/or fuel to a combustion chamber of an internal combustion engine, a first sleeve valve operable to move away from a first closed position to open the intake port to deliver the fluid for combustion in a current engine cycle, an exhaust port configured to remove an exhaust mixture from a prior engine cycle from the combustion chamber, and a second sleeve valve operable to move toward a first closed position to close the exhaust port. The closing of the exhaust port at the end of the prior cycle does not complete before the opening of the intake port begins. The system further includes a first piston moving within a first circumference of the first sleeve valve and a second piston moving within a second circumference of the second sleeve valve. The first piston includes a first shrouding feature that temporarily shrouds at least part of the intake port on a first side of the combustion chamber, and the second piston includes a second shrouding feature that temporarily shrouds at least part of the exhaust port on an opposite side of the combustion chamber from the first side such that the fluid is required to traverse at least part of a diameter of the combustion chamber to exit the combustion chamber prior to the closing being completed.

In an interrelated aspect, a method includes opening an intake port delivering a fluid including air or air and fuel to a combustion chamber of an internal combustion engine for combustion in a current engine cycle. The opening includes moving a first sleeve valve away from a first closed position. An exhaust port through which an exhaust mixture from a prior engine cycle is removed from the combustion chamber is closed, for example by moving a second sleeve valve toward a second closed position. The closing does not complete before the opening begins. At least part of the intake port on a first side of the combustion chamber is temporarily shrouded with a first shrouding feature on a first piston moving within a first circumference of the first sleeve valve, and at least part of the exhaust port on an opposite side of the combustion chamber from the first side is temporarily shrouded with a second shrouding feature on a second piston moving within a second circumference of the second sleeve valve. The shrouding requires the fluid to traverse at least part of a diameter of the combustion chamber to exit the combustion chamber prior to the closing being completed.

In some variations of the above-summarized aspects, one or more of the following features can optionally be included in any feasible combination. The first shrouding feature and/or the second shrouding feature can optionally include shoulders on the respective piston crowns that include chamfers or some other type of gap on the side of the piston corresponding to the un-shrouded part of each of the valves.

Premixing of Fuel with Exhaust.

In one aspect, a method includes creating a mixture of exhaust gases from a previous cycle of an internal combustion engine with fuel in an exhaust manifold, directing the mixture to an intake manifold of the internal combustion engine and into a combustion volume for combustion in a new cycle, adding air to the mixture, and compressing the mixture. The compressing includes reducing the combustion volume by a compression ratio. The reducing the combustion volume includes movement of a piston in a first direction. The combustion mixture is ignited and combusted to form an exhaust mixture that includes water vapor and other combustion products while generating a peak combustion temperature inside the combustion volume that is less than a pre-defined maximum peak temperature due to the amount of exhaust. The combusting includes expanding the combustion volume by an expansion ratio by movement of the piston in a second direction opposite to the first direction. The exhaust mixture is exhausted from the combustion volume.

In some variations of the above-summarized aspects, one or more of the following features can optionally be included in any feasible combination. Initiation reactions can optionally be allowed to occur within the mixture to prepare the mixture for combustion in a homogeneous charge compression mode. The adding of the air can optionally occur in the intake manifold. An amount of liquid water can optionally be added to the mixture. The adding of the amount of water can optionally include closing an intake valve from the intake manifold and then injecting water directly into the mixture in the combustion volume. Liquid-phase water can optionally be condensed from the exhaust stream. The condensing can optionally include passing the exhaust mixture through a condenser system that converts at least some of the water vapor in the exhaust stream to the liquid-phase. The combustion chamber can optionally include at least one interior surface, that can include a catalyst coating, which can optionally include catalyst particles to promote more complete combustion of at least one of hydrocarbons and carbon monoxide during formation of the exhaust mixture. The pre-defined threshold temperature can optionally be below a NO_{X} formation temperature.

Implementations of the current subject matter can include, but are not limited to, systems and methods including one or more features of the various aspects, implementations, and embodiments described herein. Certain features of one or more of the described aspects can in some examples be at least partially implemented in electronic circuitry and/or by one or more programmable processors that execute machine instructions. Articles that comprise a tangibly embodied machine-readable medium operable to cause one or more such programmable processors (e.g., computers, etc.) to result in operations described herein are also within the scope of the current subject matter. Computer systems are also described that may include one or more programmable processors and one or more memories coupled to the one or more programmable processors. A memory, which can include one or multiple computer-readable storage media, may include, encode, store, or the like one or more programs that cause one or more programmable processors to perform one or more of the operations described herein. Methods consistent with one or more implementations of the current subject matter can be at least partially implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows is a diagram illustrating aspects of an engine showing features consistent with implementations of the current subject matter;

FIG. 2 shows a diagram illustrating aspects of another engine showing features consistent with implementations of the current subject matter;

FIG. 3 shows a diagram illustrating aspects of another engine showing features consistent with implementations of the current subject matter;

FIG. 4A and FIG. 4B show diagrams illustrating a first cross-sectional view and a second cross-sectional view of a system including exhaust muffling and pollutant reduction features consistent with implementations of the current subject matter;

FIG. 5 shows a process flow diagram illustrating aspects of a method having one or more features consistent with implementations of the current subject matter relating to mufflers and/or emission control;

FIG. 6 shows a diagram illustrating aspects of a an approach to manufacturing a system having exhaust muffling and pollutant reduction features consistent with implementations of the current subject matter; and

FIG. 7 shows a process flow diagram illustrating aspects of a method for manufacturing a system having exhaust muffling and pollutant reduction features consistent with implementations of the current subject matter;

FIG. 8 shows a diagram of an engine system;

FIG. 9 shows a process flow diagram illustrating aspects of a method having one or more features consistent with implementations of the current subject matter relating to water injection;

FIG. 10A and FIG. 10B show side cross-sectional and top view diagrams of an engine system;

FIG. 11 shows a process flow diagram illustrating aspects of a method for controlling a speed of combustion in an engine;

FIG. 12A and FIG. 12B show side cross-sectional view diagrams of engine systems illustrating inlet to exhaust port flows;

FIG. 13 shows a process flow diagram illustrating aspects of a method for reducing short circuiting of inlet and exhaust flows in an engine;

FIG. 14A and FIG. 14B show side and axial cross-sectional view diagrams of engine systems illustrating crankshaft features;

FIG. 15 and FIG. 16 show side cross-sectional view diagrams of engine systems illustrating crankshaft features;

FIG. 17 to FIG. 28 include schematic views and charts relating to improved engine ports;

FIG. 29 shows a process flow diagram illustrating aspects of a method relating to improved engine ports;

FIG. 30 shows a diagram of an engine system;

FIG. 31 shows a process flow diagram illustrating aspects of a method relating to premixing of exhaust and fuel;

FIG. 32A-B and FIG. 33A-D show charts illustrating advantages of delayed ignition timing;

FIG. 34 shows a chart.

When practical, similar reference numbers may denote similar structures, features, or elements.

### DETAILED DESCRIPTION

Individually or in any feasible combination, features described herein can provide one or more improvements or advantages relative to conventional internal combustion engine technologies.

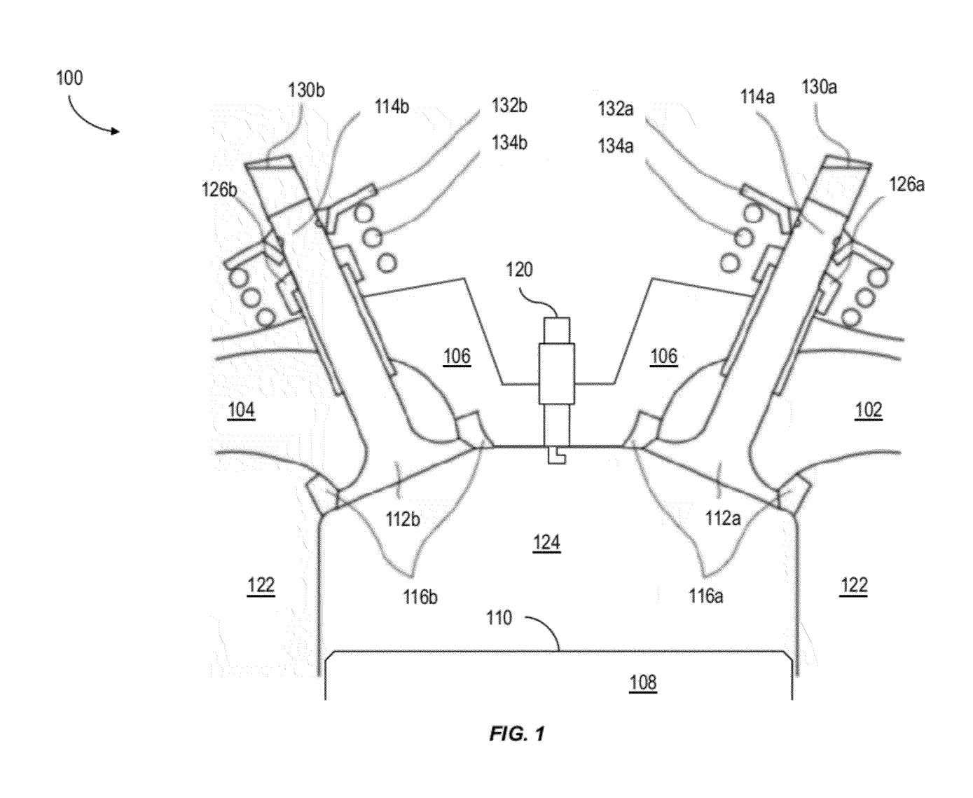

FIG. 1 shows a view of a part of an example engine 100 having one or more features that may be included in whole or in part in any given implementation of the current subject matter. As shown in FIG. 1, an inlet port 102 and an exhaust port 104 are positioned in or adjacent to a cylinder head 106 of an engine having each of one or more pistons 108 in its own cylinder. Each piston has a piston crown 110. Flow through the air inlet port 102 shown in FIG. 1 is controlled by a first poppet valve assembly including a valve head 112a, a valve stem 114a, and a valve seat 116a, while flow though the exhaust port 104 is controlled by a second poppet valve assembly including a valve head 112b, a valve stem 114b, and a valve seat 116b, respectively. In the configuration shown in FIG. 1, a spark plug 120 or other ignition source, which can be used in conjunction with a spark ignited engine, is shown passing through the cylinder head 106. Other positions for the spark plug 120 or other ignition source (e.g. along the periphery of the cylinder head 106, in the cylinder walls 122, etc.) are also within the scope of the current subject matter. For engines operated without spark ignition (e.g. diesel engines, engines operated in an HCCI mode, etc.), the spark plug 120 or other ignition source can be omitted.

The piston crown 108, the cylinder walls 122, and the cylinder head 106 define a combustion chamber or combustion volume 124 into which a mixture of air and fuel in provided using one or more approaches, including but not limited to delivery a premixed combustion of air and fuel delivered by one or more inlet ports 102, delivery of air via the one or more inlet port 102 and fuel by a direct injector (not shown in FIG. 1), or the like. More than one spark plug 120 or other ignition source can also be used. Each valve assembly can include a valve stem seal 126a, 126b, a rocker arm or valve lift arm 130a, 130b connected to one or more cams to actuate (e.g. open) the valve, and a coil or spring 132a, 132b to urge the valve into a closed position against the valve seats 116a, 116b, respectively. Spring retainers 132a, 132b can retain the springs 134a, 134b.

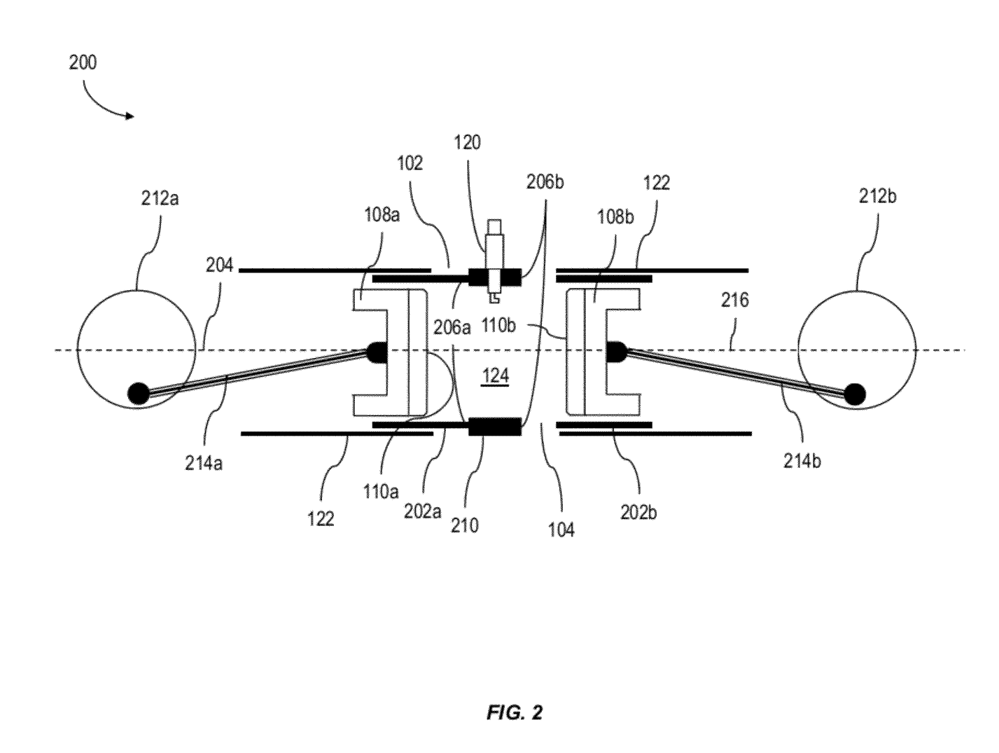

FIG. 2 shows a view of a part of another example engine 200 having features that may be included in whole or in part in any given implementation of the current subject matter. In this engine 200, an opposed piston configuration is used, in which two pistons share a common cylinder. A first piston crown 110a of a first piston 108a, a second piston crown 110b of a second opposed piston 108b, and cylinder walls 122 generally at least partially define a combustion chamber or combustion volume 124 into which air is provided via one or more air inlet ports 102 and from which burned combustion gases are exhausted via one or more exhaust ports 104. One approach to opposed piston engines involves the use of sleeve valves 202a, 202b to control flow through the one or more air inlet ports 102 and the one or more exhaust ports 104. The sleeve valves 202a, 202b can move at least in a direction parallel to an axis of translation 204 of the pistons 108a, 108b such that in a closed position they are urged into contact with valve seats 206a, 206b that can be part of a center ring or other connecting piece 210 joining two parts of an engine block that each define part of the cylinder walls 128. The center ring or other connecting piece 210 can also provide a pass-through for one or more spark plugs 120 or other ignition sources, which can be used in conjunction with a spark ignited engine. Each piston 108a, 108b can be connected to a respective crankshaft 212a, 212b by a respective connecting rod 214a, 214b.

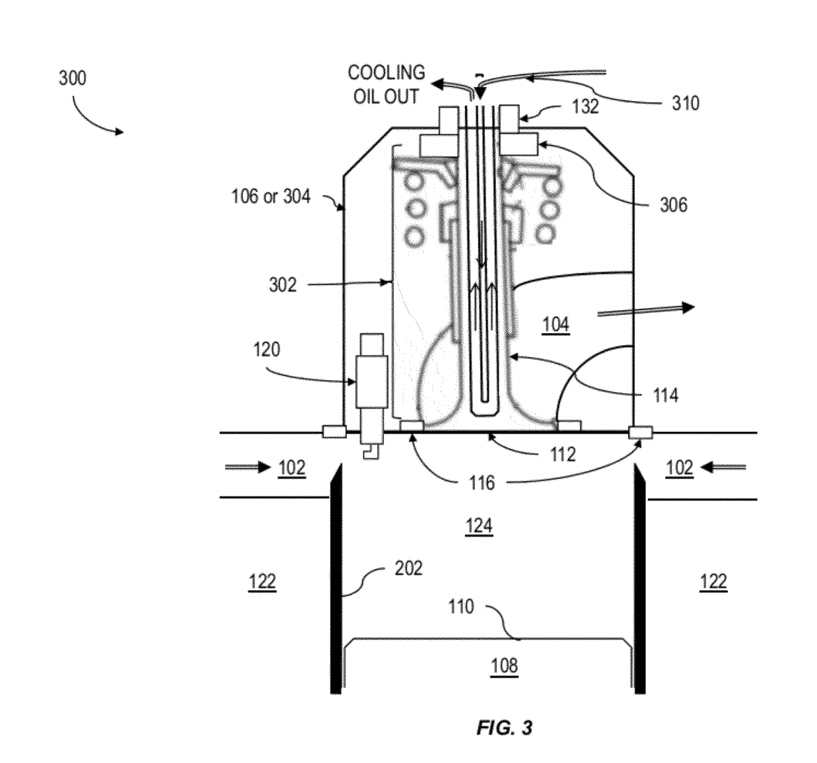

FIG. 3 shows a view of a part of yet another example engine 300 having features that may be included in whole or in part in any given implementation of the current subject matter. The engine 300 includes a poppet valve assembly 302 positioned centrally in a cylinder head 106, or alternatively in a junk head 304 such as described in co-owned and co-pending international application no. PCT/2011/055457. One or more spark plugs or other ignition sources 120 can be positioned off the center axis also in the junk head 304. As shown in FIG. 3, the one or more spark plugs or other ignition sources 120 can be offset from the center of the combustion chamber or combustion volume 124 (i.e. the volume between the piston crown 110 of the piston 108 and the cylinder head or junk head 304 as further defined at least by cylinder walls of the engine body 122, and, in some implementations, by at least one sleeve valve 202. More than one spark plug or other ignition source 120 can be included (for example in a spark-ignited engine) to enhance the burn rate of the mixture independent of the turbulence type or magnitude generated within the combustion chamber (e.g. by air or other gas flows via the inlet valve 102 and/or exhaust valve 104, by motion of the piston 102, by the shape of the piston head 118, or the like). Implementations of the current subject matter can also include more than one poppet valve 302 disposed in the cylinder head 106 or junk head 302. For example, two or more poppet valves can be positioned offset from the cylinder centerline. One or more spark plugs or other ignition sources 120 can be positioned either offset from the cylinder centerline as shown in FIG. 3, or on or near the cylinder centerline if the poppet valve or valves 302 are offset from the cylinder centerline.

The poppet valve 302 can, in one implementation, be used to open and close an exhaust port 104 while a sleeve valve 202 opens and closes an inlet port 102. Such a configuration can be used to reduce heat losses out of the combustion chamber. Alternatively, the ports can be reversed, such that the port 104 can be an inlet port controlled by the poppet valve 302 and the port 102 can be an exhaust port controlled by operation of the sleeve valve 202. This second configuration can enhance the knock resistance of the engine as a sleeve valve 202 used as an exhaust valve can be easier to maintain at a lower temperature than is a poppet valve used for controlling an exhaust port.

Using a sleeve valve 202 as the intake valve can enable high flow rates and low restrictions for either tumble or swirl styles of mixture motion enhancement, for example as described in co-pending and co-owned international patent application no. PCT/US2011/027775. If the engine is run as a diesel, resistance to knock (e.g. premature detonation of the air-fuel mixture) can be a lesser concern, so an exhaust poppet valve may not require active cooling. However, a spark ignited engine designed for high efficiency can merit ensuring that the valve is well cooled.

In an implementation in which only one poppet valve 302 is disposed in the cylinder head 106 or junk head 302, the poppet valve 302 can optionally be of larger diameter than a conventional poppet valve and can also have a large-diameter stem 114 to conduct heat away from the valve head 112 more effectively than a smaller conventional valve. Such a valve can optionally also be made of a highly conductive material, such as for example a high-strength aluminum alloy. Alternatively or in addition, the valve stem 114 and/or body can be filled with a cooling fluid, for example sodium in a steel valve.

Alternatively, and as shown in FIG. 3, the valve stem 114, actuator 306, and keeper 132 can have access holes such that an oil supply tube 310 can be inserted into the valve stem 114. The oil supply tube 310 can deliver oil near the valve head 220 inside the valve stem 114 and the clearance between the oil supply tube 310 and the valve stem 114 can allow the oil flow to exit. The oil supply tube 310 can optionally be rigid and fixed to the block, for example such that the differential motion between the valve and the engine/oil tube creates a volume change in the valve oil passages so that oil is drawn into the valve as the valve opens and ejected it as the valve closes. High heat transfer coefficients and high flow rates can be maintained with this jet and valve motion configuration so the poppet valve 302 can be maintained at temperatures below the temperature the oil would start to decompose. This approach can be used with all valve material choices. A check valve can optionally be included in or upstream of the oil supply tube or passage 310 to ensure that this pumping action produces flow of the cooling oil through the valve passages. Pumping action can also be obtained by varying the valve section where the valve stem 114 passes through a fixed cavity supplied with oil. Oil can additionally be fed from a pressurized cavity without valve-induced pumping action.

### Integrated Muffler and Emissions Control for Engine Exhaust.

A muffler or muffler system for an internal combustion engine is typically installed along an exhaust pipe leading from an exhaust manifold that collects exhaust gases exiting through exhaust ports of one or more combustion chambers of the internal combustion engine. The muffler or muffler system generally causes a reduction in exhaust noise by absorption. For example, the exhaust gases can be routed through a series of passages and chambers, which can be lined with fiberglass wool or some other non-resonating material. One or more resonating chambers can be tuned to cause destructive interference wherein opposite sound waves cancel each other out.

The term “catalytic converter” generally refers to a device used to convert undesirable combustion product compounds in exhaust gases to one or more inert or at least less undesirable target compounds. One or more catalyst substances stimulate a chemical reaction in which combustion products undergo a chemical reaction that varies depending upon the type of catalyst installed. As an example, gasoline powered light duty automobiles, motorcycles, and the like in North America typically make use of a three-way catalytic converter, which reduces oxides of nitrogen (NO, NO₂, & N₂O) and oxidizes unburned hydrocarbons and carbon monoxide (CO) to produce nitrogen (N₂), carbon dioxide (CO₂), and water (H₂O). Other types of catalytic converters include, but are not limited to, those using two-way catalysts that catalyze reactions that convert carbon monoxide and unburned hydrocarbons to carbon dioxide and water.

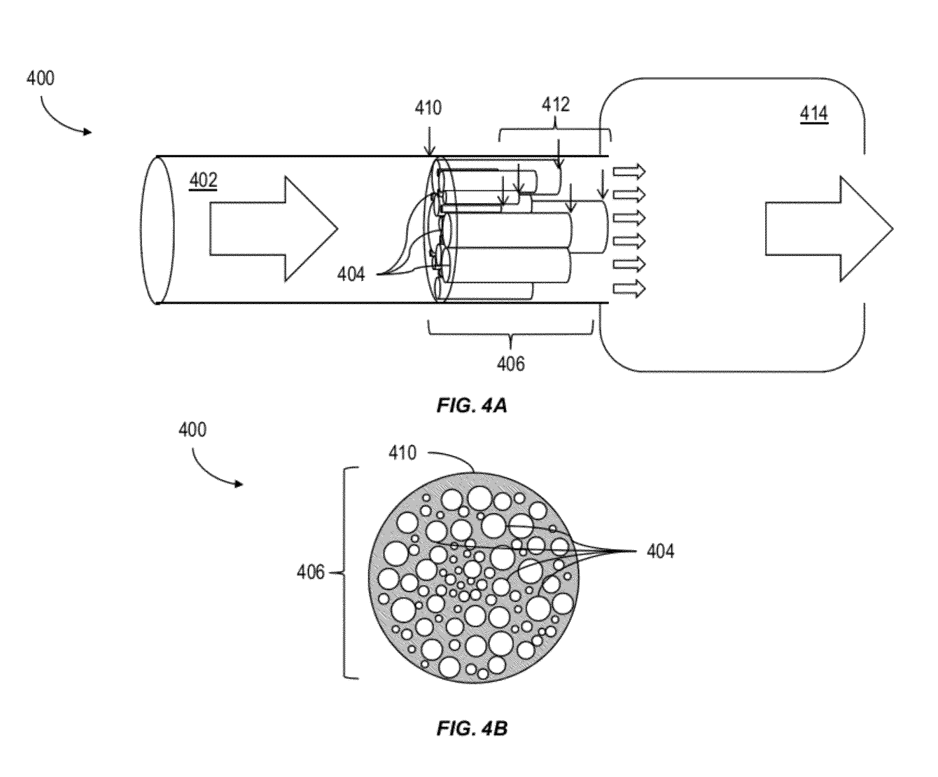

In an implementation of the current subject matter, a muffler design can include an array of tubes or passages of differing lengths and diameters whose inlet ends are presented across a cross sectional flow area of a tubular conduit that conducts exhaust gases from an exhaust gas source, such as for example an internal combustion engine. As shown in the illustrative example of FIG. 4A and FIG. 4B, an exhaust system 400 can include a tubular conduit 402 for conveying exhaust gases, for example from an internal combustion engine. Multiple smaller diameter passages or tubes 404 can be arranged in the tubular conduit 402 with their internal flow axes aligned at least approximately in parallel with the flow axis of the tubular conduit 402. As shown in FIG. 4A and FIG. 4B, the passages or tubes 404 can be arranged in a close-packed array 406 that fills or at least partially fills a cross sectional flow area of the tubular conduit 402. The passages or tubes 404 in the close-packed array can have a range of diameters and lengths with the tube length and diameter of each of the passages or tubes 404 being matched such that each of the passages or tubes 404 in the close-packed array 406 has an at least approximately equivalent flow per unit area of the passage or tube 404 from an inlet end 410 to an outlet end 412 of the array 406. Smaller diameter passages or tubes 404 are therefore shorter than larger diameter passages or tubes 404. The outlet end 412 of the passages or tubes 404 in the array 406 can open into a collector 414 that has a sufficiently large collector volume to present a similar pressure across the outlet faces of all the passages or tubes 404. Because the gas velocity is similar in all the passages or tubes 404 due to the comparable pressure drop across each tube, the pressure wave of the exhaust gases can arrive in the collector 414 at a different time from each of the passages or tubes 404 of differing size. This effect can spread the initial pulse out by a factor that is proportional to the length difference in the passages or tubes 404.

A similar pressure drop can be provided across all of the passages or tubes 404 by virtue of a given volume of exhaust gases entering the passages or tubes at the inlet end 412 of the array 406 at the same time and then exiting into the collector 414 that easily communicates an equal pressure across all of the passages or tubes 404 at the outlet end 412 of the array 406. As noted, the length and cross-sectional flow area is matched for each passage or tube 404 in the array 406 to cause each passage or tube 404 to flow similar amounts of gas per unit area of the cross-section of each passage or tube 404.

In an implementation, the number of passages or tubes 404 of each size can advantageously be selected such that an approximately equivalent amount of the exhaust gases passes through each size of passage or tube 404. In other words, a number of passages or tubes 404 of a smaller size in the array 406 can be greater than a number of passages or tubes 404 of a larger size such that the total cross sectional area of all passages or tubes 404 of each size is approximately equal. This calculation can be approached either from the perspective of a set passage or tube size and adjustment of the number of passages or tubes 404 of each size or from the perspective of a set number of passages or tubes 404 and adjustment of the cross-sectional areas of those tubes to achieve the advantageous condition noted above.

In this manner, an approximately equivalent amount of sound energy can be delivered to the outlet end 414 of the array 406 from each size of passages or tubes 404. Because of the differing lengths of the passages or tubes 404, the approximately equivalent amount of sound energy from each size of passages or tubes 404 arrives in the collector staggered in time such that the acoustic wave encounters negative interference that at least partially cancels out its amplitude. Even if the total flow through each different size of passages or tubes 404 is not perfectly balanced among the sizes of passages or tubes 404, at least some portion of the sound energy will be attenuated.

In an optional variation, the exhaust gases can pass from the collector 414 to another, second array of variable length passages or tubes (not shown in FIG. 4) similar to the array 406 of passages or tubes 404. The second array can further spread out the exhaust pulse energy over a distance equal to approximately twice the length differences of the passages or tubes 404 in the first and second arrays. When the pulse length is increased, the magnitude is decreased and so the sound is attenuated.

To provide an integrated muffler and catalytic converter consistent with an implementation, the interior surfaces of the passages or tubes 404 in the first array 406 and/or the second array can be coated with a catalyst. The smaller diameter or cross sectional area passages or tubes can be effective in reacting with the exhaust gas compounds despite their relatively short length because diffusive, random motion of gas and particles in these smaller passages or tubes 404 can quickly cause most molecules to contact the surface of the catalyst. Larger diameter or cross sectional area passages or tubes can require more time for the molecules to cross a larger distance. However, as noted above, the larger passages or tubes are longer, thereby allowing a greater residence time in the passage or tube for random motion to occur to bring combustion product compounds into contact with the catalyst material on the interior surfaces.

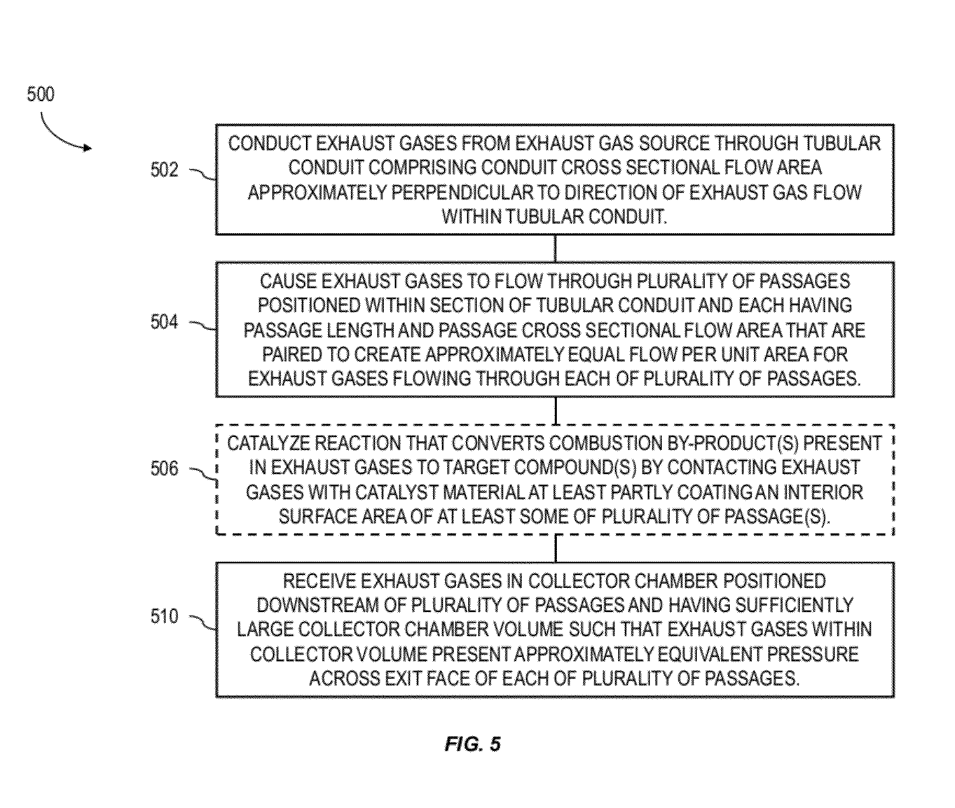

FIG. 5 shows a process flow chart 500 illustrating method features, one or more of which may be present in an implementation of the current subject matter. At 502, exhaust gases are conducted from an exhaust gas source through a tubular conduit that includes a conduit cross sectional flow area approximately perpendicular to a direction of exhaust gas flow within the tubular conduit. The tubular conduit need not have a symmetrical cross section, and the cross section need not be constant in either shape or size along the length of the conduit. At 504, the exhaust gases flow through a plurality of passages positioned within and at least partially filling the conduit cross sectional flow area at a section of the tubular conduit. Each of the plurality of passages has a passage length and a passage cross sectional flow area. For each of the plurality of passages, the passage length and passage cross sectional area are paired to create an approximately equal flow per unit area for the exhaust gases flowing through each of the plurality of passages. At 506, at least part of the interior surfaces of one or more of the plurality of passages can optionally be coated with a catalyst material as discussed elsewhere herein to catalyze a reaction that converts at least one combustion by-product present in the exhaust gases to at least one target compound by contacting the exhaust gases with the catalyst coating. The exhaust gases are received at 510 in a collector chamber positioned downstream of the plurality of passages. The collector chamber has a sufficiently large collector chamber volume such that the exhaust gases within the collector volume present an approximately equivalent pressure across an exit face of each of the plurality of passages.

The passages or tubes 404 can be formed of metal or ceramic or some other suitable material for containing and conducting exhaust gases generated by an engine. The interior surfaces of the passages or tubes 404 can have a roughened surface, for example one generated by applying a coating of a roughening agent. The roughened surface, which can increase the available interior surface area of the passages or tubes 404, can be coated or otherwise at least partially covered with a layer of a catalyst material that can facilitate reactions of one or more combustion product or pollutant species in the exhaust gases to generate more desirable end products or target compounds. Such passages or tubes can be made from, for example, rolled corrugated sheet metal where the corrugations vary with the length of the formed cavity. Alternatively, passages or tubes of differing diameters can be bored into a metal or ceramic insert shaped to fill or at least partially fill the conduit cross sectional area in the section of the tubular conduit. The bored passages or tubes can be arranged in a pattern such that smaller diameter passages or tubes are on a first side of the metal or ceramic insert and the passages or tubes increase in diameter moving across the metal or ceramic insert toward an opposite side of the metal or ceramic insert. A downstream end of the metal or ceramic insert can be cut at an angle to cause the lengths of the tubes or passages such that smaller diameter or cross sectional area passages or tubes have shorter lengths and larger diameter or cross sectional area passages or tubes have longer lengths so that the flow rate across the tube 402 remains generally uniform. Each the multiple passages or tubes has a flow per unit area that is approximately equal.

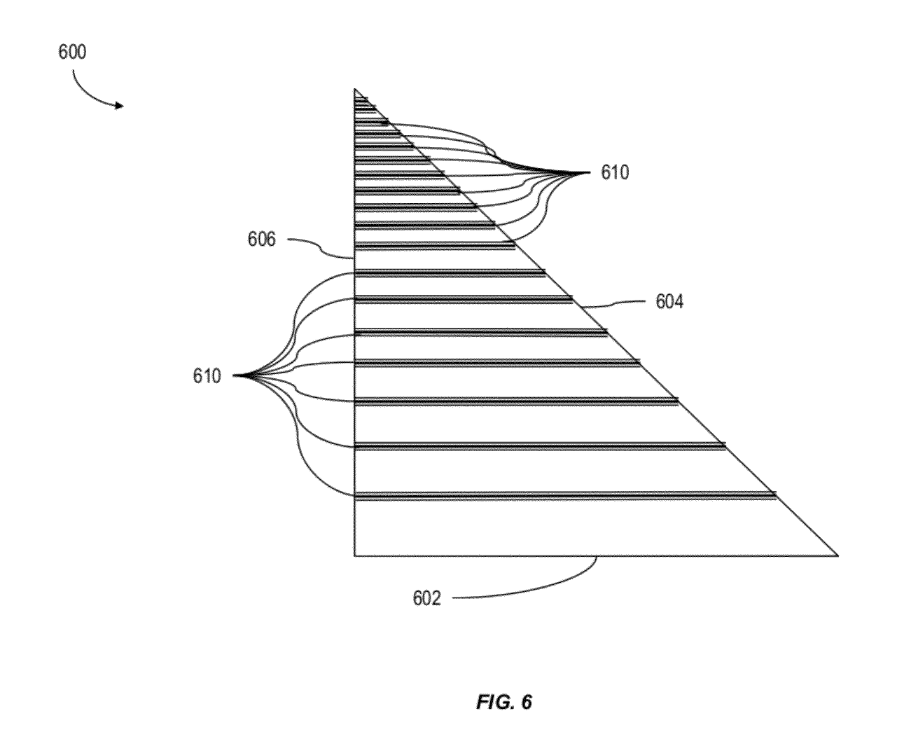

In an alternative implementation, an example of which is illustrated in FIG. 6, a triangular piece of sheet metal 600, which has a first side 602, a second side 604, and a third side 606, can have a series of corrugations 610 formed upon it. The corrugations can be spaced relatively far apart closest to the first side 602 to which they are aligned in parallel and can be progressively closer to one another at greater distances from the first side 602. When the triangular piece of sheet metal 600 is rolled along a rolling axis approximately perpendicular to the first side 602, the forms passages can conform to the features described for various implementations of the current subject matter. In other words, the passages formed by the rolled up corrugations can be of the shortest length for the smallest passages with progressively longer passage lengths formed for passages having grater cross sectional area. It should be noted that, while FIG. 6 shows a right triangle shape for the piece of sheet metal, other types of triangular shapes are also within the scope of the current subject matter. The piece of sheet metal can optionally include one or more materials in addition to or instead of sheet metal.

Unlike a conventional catalytic converter that requires a catalyst core or substrate (e.g. a ceramic monolith) upon which the catalyst material is supported, implementations of the current subject matter can provide support for the catalyst material on the flow surfaces of the same elements that provide the acoustic dampening as discussed above. In some implementations, a wash coat, which can be a carrier for the catalytic materials that is used to disperse the materials over a high surface area, can be applied to at least part of the interiror surfaces of the passages or tubes in the array 406. Aluminum oxide, titanium dioxide, silicon dioxide, a mixture of silica and alumina, or the like can be used as a wash coat carrier material that is applied via a slurry. The catalytic materials can be suspended in the slurry or otherwise absorbed into or adsorbed onto the carrier materials in the wash coat slurry prior to applying the wash coat to the interior surfaces of the tubes or passages. Wash coat materials can optionally be selected to form a rough, irregular surface, which can increase the surface area compared to the smooth surface of the bare material of the tubes or passages to maximize the available catalytically active surface available to react with the exhaust gases. The catalyst material itself can optionally include a precious metal. For example, palladium can be used as an oxidation catalyst, rhodium can be used as a reduction catalyst, and platinum can be used both for either or both of reduction and oxidation. Cerium, iron, manganese and nickel can also be used.

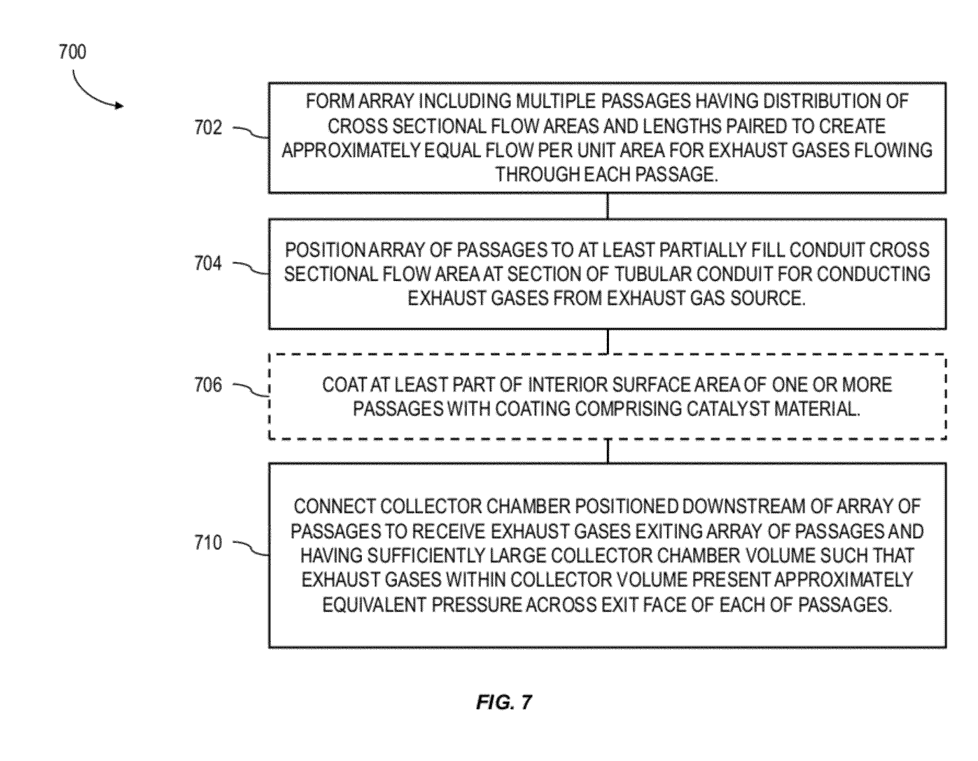

FIG. 7 shows a process flow chart 700 illustrating method features, one or more of which may be present in an implementation of the current subject matter. At 702, an array of passages that includes a plurality of passages having a distribution of cross sectional flow areas can be formed. Each passage of the plurality of passages can have a passage length and a passage cross sectional flow area that are paired to create an approximately equal flow rate per unit cross sectional area for exhaust gases flowing through each of the plurality of passages. The array of passages can be positioned at 704 such that the array of passages at least partially fills a conduit cross sectional flow area of a section of a tubular conduit for conducting exhaust gases from an exhaust gas source. At 706, at least part of an interior surface area of one or more of the plurality of passages can be coated with a coating that includes a catalyst material. A collector chamber positioned downstream of the array of passages to receive exhaust gases exiting the plurality of passages can be provided at 710. The collector chamber can have a sufficiently large collector chamber volume such that the exhaust gases within the collector volume present an approximately equivalent pressure across an exit face of each of the plurality of passages.

B. Water-Injected Internal Combustion Engine with Asymmetric Compression and Expansion Ratio.

Another implementation includes addition of water to the combustion chamber of an internal combustion engine. A combustion modulation additive consistent with one or more implementations can be water or exhaust gases from a previous cycle of the internal combustion engine. Peak combustion temperatures in internal combustion engines can be sufficiently high to form large amounts of nitrogen oxides when operating in a high efficiency mode, particularly under lean (e.g. excess air) combustion conditions. After-treatment is therefore generally required to reduce the nitrogen oxides back to compounds of lesser environmental concern. Such treatment processes can introduce additional cost and complexity to an engine.

A water injected internal combustion engine using a combustion control additive that includes liquid water can optionally include asymmetric compression and expansion ratios. The largest portion of the wasted energy in a modern engine is typically the hot exhaust gas. Recovering even a relatively small fraction of this wasted energy can substantially improve the efficiency of the engine. Water injection can be used to reduce the air-fuel mixture temperatures within the combustion chamber of an engine, which can result in benefits that can include, but are not limited to, avoidance or reduction of the incidence of auto-ignition, moderating the speed of combustion, and the like.

In one implementation, a water injection approach can be combined with an asymmetric compression/expansion engine. Water can be injected into the combustion chamber 124 early enough in the cycle that it becomes at least approximately homogeneously dispersed in the air-fuel mixture. The amount of water can be large enough to absorb sufficient heat to limit the peak temperature within the combustion chamber after combustion to less than the NO_{X} formation threshold (typically approximately 2000 K). In one example, the water injection rate can be approximately double the fuel flow rate on a volumetric basis. After combustion, additional water can optionally be injected to the combustion chamber 124. The amount of additional water can be sufficient to reduce the temperature of the exhaust gases and water vapor in the combustion chamber 124 as they expand during the expansion stroke of the piston to slightly above the condensation temperature of water vapor. An asymmetric expansion ratio can be used to allow full expansion of both the steam that has formed and the combustion products, which also include generated water vapor for a hydrocarbon or hydrogen-based fuel.

The exhaust stream can optionally be passed through a condenser to recover at least some of the water vapor to minimize the amount of user maintenance required to run the system. For example, during normal operation it can be possible to condense sufficient water to match the usage rate. At high power operation, a net loss of water may occur. However, an onboard reservoir can be refilled with either outside make up water or condensation of water vapor from exhaust gases.

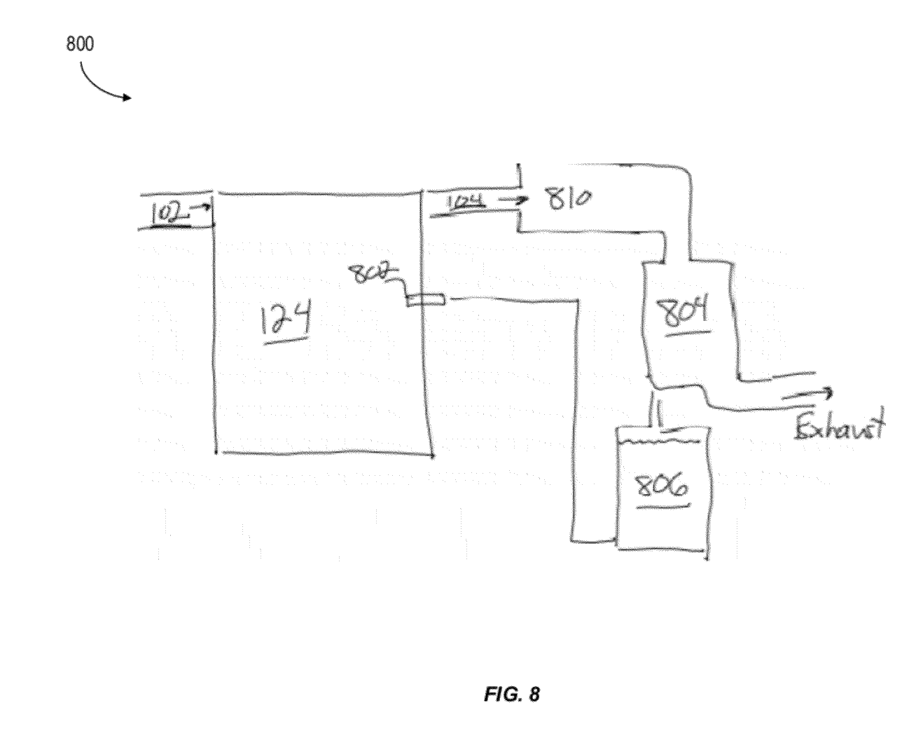

In an implementation illustrated in FIG. 8, air and fuel can be drawn into a combustion chamber 124 of an engine cylinder, either separately or as a pre-mixed air-fuel mixture. An inlet valve controlling an inlet port 102 can be closed, and sufficient water can be injected to the combustion chamber 124 by a water injection port 802 to limit the peak temperature occurring in the combustion chamber 124 during combustion (as noted, in some examples the injection rate of water can be about twice that of the fuel although other ratios are also within the scope of the current subject matter). The mixture can be compressed, in one example by a ratio of approximately by 10:1 for gasoline and spark ignition or higher for homogeneous charge compression ignition (HCCI). After the flame front has passed, more water can be injected (in one example approximately three or four times the amount of fuel injected) at moderately high pressure (for example approximately 2000-3000 psi) to increase the chamber pressure to approximately 90 atmospheres or approximately 1400 psi. After expansion of the burning combustion mixture plus initially added water and additional added water, for example by a ratio of about 35:1 to 124 1.2 atmospheres, the combusted mixture can be exhausted from the combustion chamber 124 to a condenser 804. The condenser 804 can deliver condensed water to a reservoir 806 from which water can be delivered to the water injection port 802 for injection into the combustion chamber 124.

By adding water before ignition and adding additional water after ignition, the exhaust can be substantially cooled, for example to approximately 120° C., and the peak temperature in the combustion volume 124 can be maintained below the NO_{X} threshold, for example approximately 2000 K. This approach can minimize the amount of heat that the condenser 804 is required to remove to recover liquid water from the water vapor in the exhaust. It can also reduce the exhaust gas temperature below that necessary for proper catalyst activity, so the exhaust gas is advantageously free of contaminants that a catalytic converter would ordinarily remove. Alternatively, the condensed water can absorb at least some of the remaining contaminants in the exhaust gases and recycle them back into the combustion chamber on reuse of the water rather than allowing them to be vented to the atmosphere with the exhaust gases exiting the condenser.

In some implementations, the low peak temperature experienced within the combustion chamber 124 can allow interior surfaces of the combustion chamber 124 to be coated with catalyst particles to aid in the complete combustion of hydrocarbons, carbon monoxide, etc. and. Such coatings can be combined with ceramic coatings that can further limit the amount of heat lost to the engine block.

An exhaust gas temperature measurement can optionally be incorporated with a system consistent with implementations of the current subject matter to ensure that the amount of water injected is not so large that it cools the exhaust below the condensation temperature. By avoiding condensation of the generated water vapor prior to the condenser 804, for example in the combustion chamber 124, in the exhaust port 104 or exhaust manifold 810, etc., the risk of having oil and water mix in the engine's lubrication system can be reduced or minimized. During start up of an engine from a cold condition, the injection of water can be delayed to not occur until the exhaust gas temperature is determined to be sufficiently high to avoid unwanted condensation of water vapor. In another example, the operating temperature of the oil can be maintained above a temperature threshold corresponding to a condensation point of the water. Proper monitoring of the engine can allow for minimal if any condensation, thereby allowing for traditional materials to be used in construction.

Consistent with one or more implementations of this aspect, water can be added either in an intake manifold (not shown) or by direct injection into the combustion chamber 124. To limit the pumping work needed, it can be advantageous to use a high-pressure injection directly into the combustion chamber 124 at a time as late on the compression stroke as possible to obtain a homogeneous mixture of air, fuel, and water before combustion starts. In an example in which fuel and air are mixed in an intake manifold before delivery to the combustion chamber, a single injection system can provide the water directly to the combustion chamber 124. For an engine that also uses direct injection of fuel to the combustion chamber 124 (e.g. a HCCI engine or a diesel engine), a fuel injection system and a water injection system can both be included.

The use of water injection to limit the peak temperatures that occur within a combustion volume of an engine can also be advantageous in turbocharged engines, in which exhaust gas temperatures can get sufficiently high that extra fuel must be added to provide sufficient cooling that results from evaporation of the fuel. In some conventional turbocharged engines, this additional fuel is simply passed out the tailpipe or to the catalytic converter and is therefore effectively wasted at best or emitted as pollutants if the catalyst fails to process the unburned fuel. Using an implementation of the current subject matter, water injection can be used in turbocharged engine to keep the temp down to eliminate or reduce NO_{X} formation. The addition of the water can also lower the exhaust temperature to eliminate or reduce the need to waste fuel to keep the turbo cool.

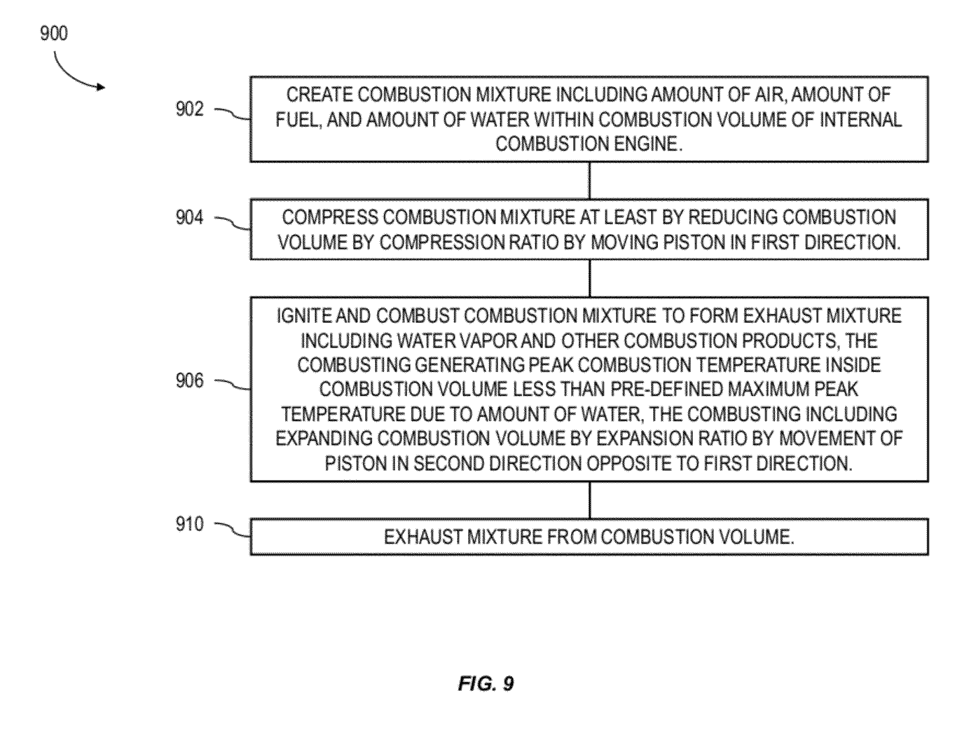

FIG. 9 shows a process flow chart 900 illustrating features of a method, at least some of which are consistent with implementations of the current subject matter. At 902 a combustion mixture that includes an amount of air, an amount of fuel, and an amount of water is created within a combustion volume of an internal combustion engine. The combustion mixture is compressed at 904, for example by reducing the combustion volume by a compression ratio. The reducing of the combustion volume includes moving a piston in a first direction. At 906, the combustion mixture is ignited and combusted to form an exhaust mixture that includes water vapor and other combustion products. The combusting generates a peak combustion temperature inside the combustion volume that is less than a pre-defined maximum peak temperature due to the amount of water. The combusting includes expanding the combustion volume by an expansion ratio, and the expanding includes movement of the piston in a second direction opposite to the first direction. At 910, the exhaust mixture is exhausted from the combustion volume.

### Controlled Combustion Duration for HCCI Engines

Using conventional approaches, high equivalence ratio homogeneous charge compression ignition (HCCI) combustion can result in the generation of pressures within the combustion volume of an internal combustion engine that are sufficient to cause damage to the engine. The equivalence ratio is defined as the inverse of the ratio of the actual air/fuel ratio of an air-fuel mixture to the air/fuel ratio necessary to produce stoichiometric combustion, which is normally referred to as lambda (λ). A higher value of lambda indicates a leaner air/fuel ratio in which excess air is provided in the combustion chamber relative to that necessary for stoichiometric combustion of the fuel. Conversely, a high equivalence ratio indicates a richer air/fuel ratio in which excess fuel is provided in the combustion chamber relative to that necessary for stoichiometric combustion of the fuel.

An equivalence ratio close to or exceeding 1 can lead to very explosive combustion conditions in the combustion chamber and can lead to a very short combustion (e.g. “burn”) duration that more closely resembles an explosion, with the associated material stresses and other modes of damage that an explosive event can entail, than a burn. To avoid this condition, it can be advantageous for the air-fuel mixture in the combustion chamber to experience a relatively controlled combustion event that progresses in an at least semi-orderly manner with a flame front moving through a volume of the air-fuel mixture.

Consistent with one or more implementations, high equivalence ratio HCCI can be used with an extended combustion event duration for a combustion mixture within the combustion volume. In some implementations, a combustion chamber design that forces the flame front of the burning combustion mixture to follow a circuitous path to complete the burn can extend the combustion event duration. An example of such a feature can include creating or intentionally allowing the existence of one or more areas of internal surface contacting the combustion volume that are at an elevated temperature (e.g. a “hot spot”) sufficient to serve as a combustion initiator or ignition location. A flame front guidance cavity can be provided within the combustion chamber to extend away from such an ignition location where a flame front begins. The flame front can thereby be forced to follow this flame front guidance cavity through a distance. The pressure rises as the flame front proceeds along the flame front guidance cavity, but because the dwell time at an elevated pressure is relatively small, the whole of the air-fuel charge volume can be prevented from igniting all at once.

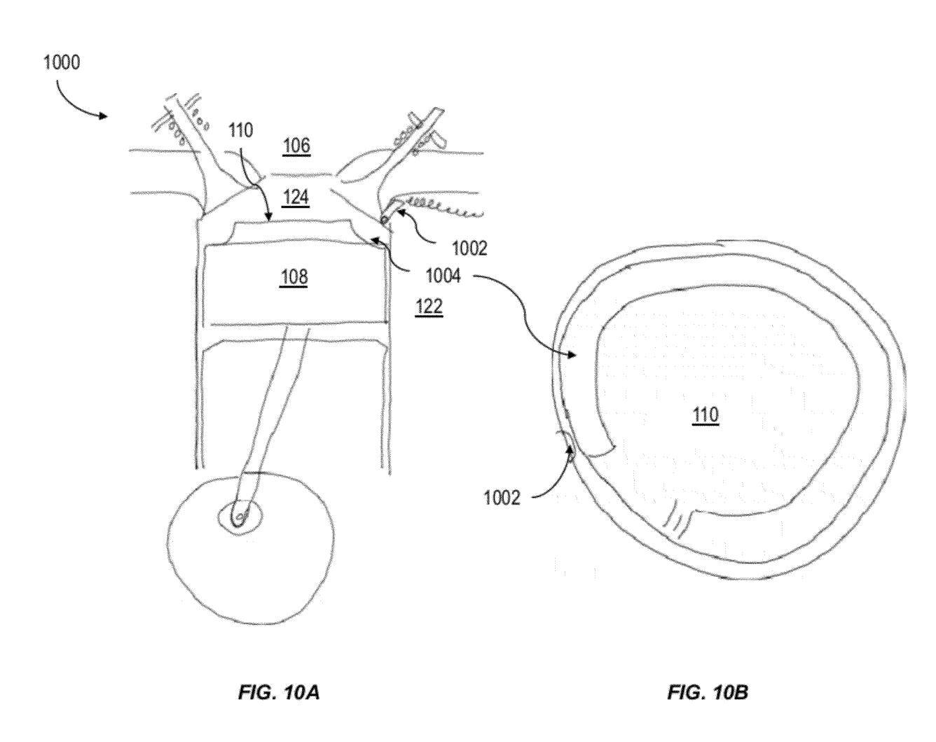

In one example illustrated in FIG. 10A and FIG. 10B, an combustion initiation location 1002, for example a glow plug, or alternatively an uncooled or otherwise heated area of the internal surface of a combustion chamber 124, can be positioned at a spot on or near the cylindrical wall 122 of the combustion chamber 124 or toward the periphery of a cylinder head 106 to provide a starting place for combustion of the fuel-air mixture in the combustion chamber 124. The glow plug can be adjacent to a shoulder 1004 formed around a periphery on a piston crown 110. The shoulder 1004 can limit the flame front from traveling either one direction around the edge of the combustion chamber 1004 or across the quench zone between two pistons in an opposed piston engine (not shown in FIG. 10). A recess can be provided such that the flame can follow a path around the piston crown 110. As an illustrative example, if the flame front can be required to travel approximately 100 mm before reaching the end of the flame front guidance cavity due to the use of a piston crown geometry consistent with an implementation of the current subject matter, at a pressure wave velocity of approximately 70 meter/sec, it would take approximately 1/700 sec to complete. At an engine revolution speed of 3600 revolutions per minute (rpm), this travel period would equate to approximately 31 crank degrees. Such a combustion profile can more closely resemble that of a normal spark ignition burn duration.

In other possible variations, the shape and location of a flame front guidance cavity can be adjusted to obtain a desired combustion event duration and to minimize surface area in contact with the burning mixture, thereby reducing heat losses from the combustion chamber 124. The engine can be operated in a peak temperature regime that is sufficiently far from an auto ignition threshold for the air-fuel mixture so that mixture will burn and not knock. More than one start of ignition point can be used to adjust the combustion event duration in relation to a knock limit of the engine.

In another approach consistent with one or more implementations of the current subject matter, an insulating coating can be applied unevenly across a piston crown such that a surface temperature of the piston crown varies from one side of the combustion chamber to the other, thereby causing an air-fuel mixture in contact with the piston crown to first ignite near a hotter region of the piston crown surface such that a flame front can propagate from the initial ignition location in a relatively controlled manner. The combustion chamber can in some implementations also or alternatively be partitioned into multiple chambers such that the fuel-air mixture in a first of the multiple chambers is caused to ignite first and then combustion products spilling into adjacent chambers can ignite the fuel-air mixture in those chambers with a time delay. A variable compression ratio can also be used produce conditions within the combustion chamber that are at or near those required for HCCI operation. A glow plug or the like can be used to adjust the ignition timing between different cylinders.

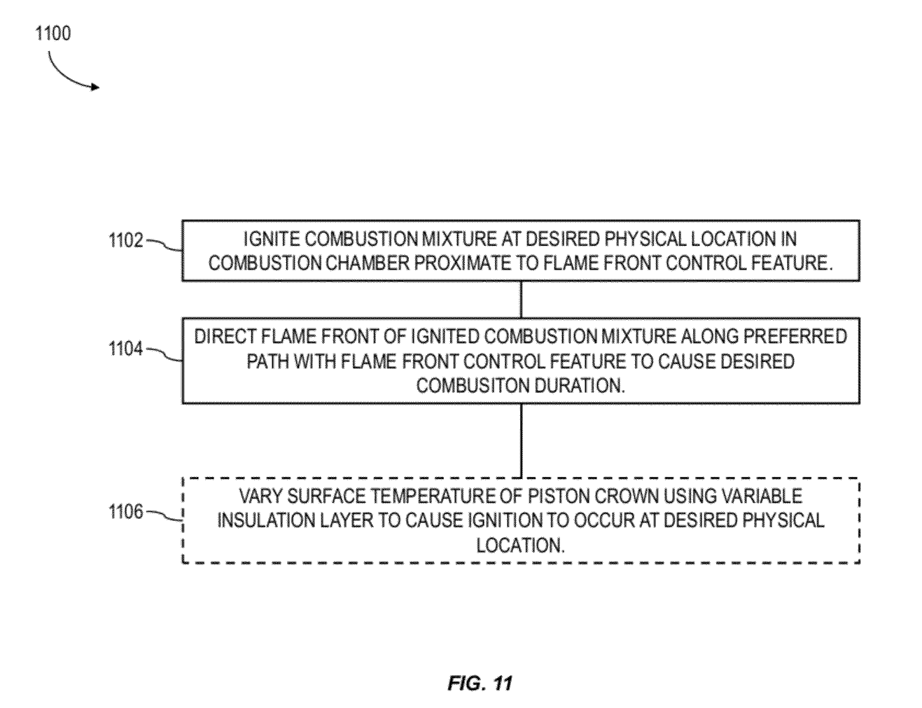

FIG. 11 shows a process flow chart 1100 illustrating features of a method, at least some of which are consistent with implementations of the current subject matter. At 1102, a combustion mixture is ignited in a combustion chamber of a homogeneous charge compression ignition engine. The igniting includes causing ignition at a desired physical location proximate to a flame front control feature. At 1104, a flame front of the ignited combustion mixture is directed along a preferred path within the combustion chamber. The directing includes guiding the flame front with the flame front control feature to cause a desired combustion duration. At 1006, a surface temperature of a piston crown in the combustion chamber can optionally be varied using a variable insulation layer on the surface of the piston crown to cause the igniting to occur at the desired physical location.

### Piston Shrouding of Sleeve Valves

In another implementation, an internal combustion engine can include piston shrouding of the sleeve valve. Conventional engines utilizing sleeves valves can suffer from overlap of an exhaust sleeve valve and an intake sleeve valve, which can allow short circuiting of an inlet charge to a combustion cylinder/chamber almost directly out the exhaust valve due to the proximity of the two valves for the whole circumference of the cylinder. Traditional poppet valves can also include a region of the combustion chamber that can have short circuiting. However, this region can be a small portion of the circumference of the valve. Flow from inlet to exhaust away from the near regions of the valves can tend to purge the combustion chamber of spent gas left from the previous cycle.

It can be challenging to operate valves at a sufficiently high speed to cause them to provide minimal restriction to the flow into and out of the engine. Designing in an overlap period during which both valves are open at the same time can allow for more time to get the valve open to match the flow requirements of the moving pistons. However, it can be difficult to control the gas movement and timings such that no unburned fuel is allowed to go directly out of the exhaust and such that minimal exhaust is allowed to push into the inlet port 102, or be retained in the combustion chamber 124.

The current subject matter can provide an engine in which an interaction between the piston location and the valve location forces the openings of the intake and exhaust to be at opposite sides of the combustion chamber. With openings at opposite sides of the combustion chamber, intake flow that would otherwise be pulled in by the pressure wave in the exhaust can instead sweep the residual combustion products ahead of it. By timing the closing of the exhaust valve, the intake charge can be allowed to purge a large portion of the residual mixture, for example approximately 75%, before closing the exhaust valve and safely capturing all the intake charge in the chamber, thereby limiting escape of unburned fuel into the exhaust pipe.

Done properly, this approach can facilitate increasing the mass flow in the engine by the effectiveness of the purge times (the combustion chamber volume/the displaced volume). In one example, a well tuned engine at a 10:1 compression ratio can yield an approximately 10% improvement in mass flow over a non purged case.

In one implementation, the crown of the piston can be caused to block the port as the valve first opens. Alternatively, in the exhaust valve case, the crown of the piston can be caused to block this port as it is just closing. For an implementation applied to the intake valve, the piston can arrive at top dead center as the valve begins to open. If the crown of the piston is already above the valve seat, it blocks the flow. However, if there is a chamfer cut on about a quarter of the circumference of the piston crown, as the valve opens it is not shrouded in the area where the chamfer is cut. In this manner, flow into the cylinder can be directed to enter through this chamfer region. In the exhaust valve case, if the piston crown blocks the valve opening except for a similar chamfer region, the exhaust flow can then be constrained to leave the chamber at that chamfer region. Arranging the pistons such that the intake piston chamfer is on the opposite side of the chamber from the exhaust chamfer can force the flow to cross the chamber purging the exhaust gas as the intake enters.

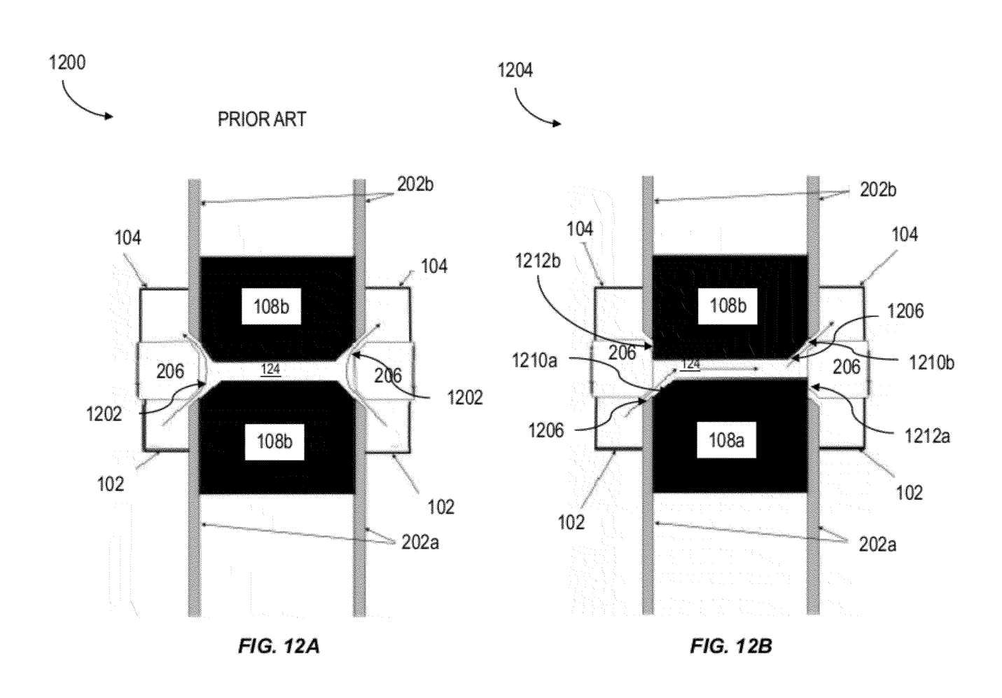

FIG. 12A and FIG. 12B respectively illustrate problems with short circuiting 1202 of flow through an inlet port flow 102 to an adjacent exhaust port 104 in a conventional engine 1200 and a solution in which flow 1206 from the inlet port 102 to the exhaust port 104 is forced through the bulk of the combustion chamber 124 in an engine 1204 employing one or more features consistent with implementations of the current subject matter. As shown in FIG. 12B, the pistons 108a, 108b can each include a chamfer feature 1210a, 1210b on opposite sides of the pistons. Thus, in the example of FIG. 12B, a first chamfer 1210a on the inlet piston 108a can allow flow through an adjacent side of the inlet port 102 while the piston crown 110a on the opposite side of the inlet piston 108a obstructs the opposite side of the inlet port 102. At the same time, while the exhaust port 104 is still open, a second chamfer 1210b on the exhaust piston 108b and on the opposite side of the combustion chamber from the first chamfer 1210a can allow flow out through the exhaust port 104 while the piston crown 110b on the opposite side of the exhaust piston 108b obstructs the opposite side of the exhaust port 104 that is closest to the unobstructed side of the inlet port 102. A shoulder 1212a, 1212b or other shrouding feature disposed opposite each chamfer 1210a, 1210b can temporarily shroud part of each respective port to prevent short-circuiting.

In an additional variation, the chamfer can bring the rings closer to the combustion gases. For example, if the chamfers are disposed at a 90° rotation to the spark plugs, then they will see the hot gases last and will have a lower heat load. An optimum of the perimeter of the combustion taken up by each chamfer 1210a, 1210b can optionally be approximately 30° arc in some examples because of flow coefficients of the orifices to the inlet and exhaust ports. Other arc lengths of the chamfer features are within the scope of the current subject matter as well. The pressure differences across the combustion chamber 124 can allow an efficient purge of the combustion chamber with less opening of the valves. This can be advantageous as larger simultaneous openings of the first and second sleeve valves 202a, 202b can lead to increased short circuiting.

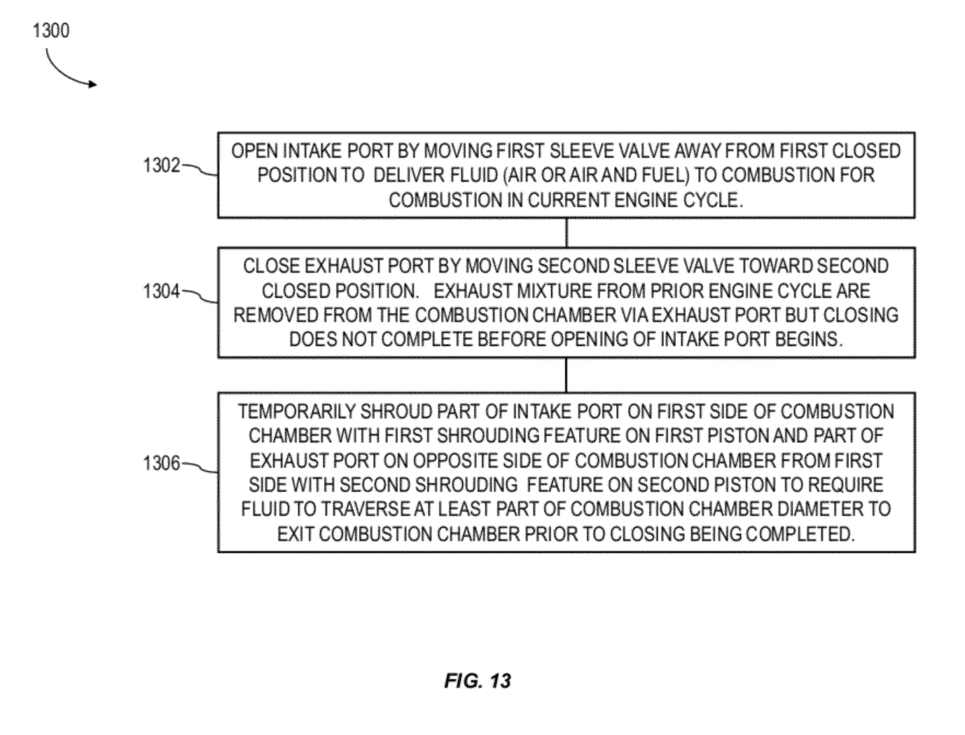

FIG. 13 shows a process flow chart 1300 illustrating features of a method, at least some of which are consistent with implementations of the current subject matter. At 1302, an intake port is opened to deliver a fluid that includes air and/or fuel to a combustion chamber of an internal combustion engine for combustion in a current engine cycle. The opening includes moving a first sleeve valve away from a first closed position. At 1304, an exhaust port through which an exhaust mixture from a prior engine cycle is removed from the combustion chamber is closed. The closing includes moving a second sleeve valve toward a second closed position, but the closing does not complete before the opening begins. At 1306, at least part of the intake port on a first side of the combustion chamber is temporarily shrouded with a first shrouding feature on a first piston moving within a first circumference of the first sleeve valve. At the same time, at least part of the exhaust port on an opposite side of the combustion chamber from the first side is also temporarily shrouded with a second shrouding feature on a second piston moving within a second circumference of the second sleeve valve. The shrouding requires the fluid to traverse at least part of a diameter of the combustion chamber to exit the combustion chamber prior to the closing being completed. The first shrouding feature and the second shrouding feature can be shoulders on the respective piston crowns that include chamfers on the side of the piston corresponding to the un-shrouded part of each of the valves.

### Low Element Count Bearing

In another implementation, a low element count bearing is provided. Conventional crankshafts are typically supported by bearings on either side of the connecting rod. Very small engines have been made that have just one side supported (for example “weed-whacker” such as is available from MTD Products of Valley City, Ohio). However, larger engines generally cause too much bending and bearing load to be supported in such a cantilevered manner.

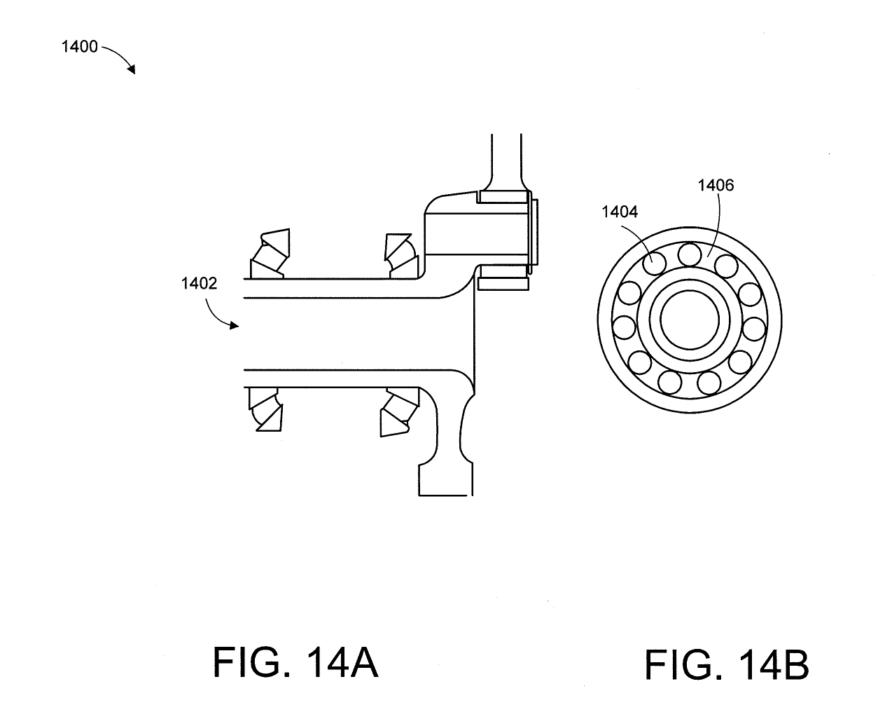

Increasing the rigidity of a cantilever crankshaft 1400 such as is shown in FIG. 14A and FIG. 14B can be achieved by increasing the diameter of the crankshaft 1402 itself. Additionally, changing the bearing type from a ball bearing to a roller bearing, which can be either tapered or straight, can increase the capacity of the main support bearing. However, as the capacity of the roller is generally much higher than the ball bearing, the roller can be run without a full complement of rollers in order to keep the friction, and cost, down in a large diameter bearing. As shown in the end view of FIG. 14B, rollers 1404 can be alternated with gaps 1406 in which no roller is included.

Caged rollers can also be used for the connecting rod bearing for reducing friction. The connecting rod can be retained with a hardened washer and a snap ring on the outside edge of the connecting rod bearing journal of the crank. The crankshaft connection drive between the two bearings can be removed for the cantilevered crank to keep the engine width to a minimum.

In some implementations, a large diameter crank can be hollow to save weight. The connecting rod journal can be hollow as well to save on original weight and the added weight needed for balance. Plane bearings can be used on both the main and/or the connecting rods. If the angularity is small compared to the oil film thicknesses, then the impact can be relatively low. Plane bearings can be more tolerant than rollers to misalignment.

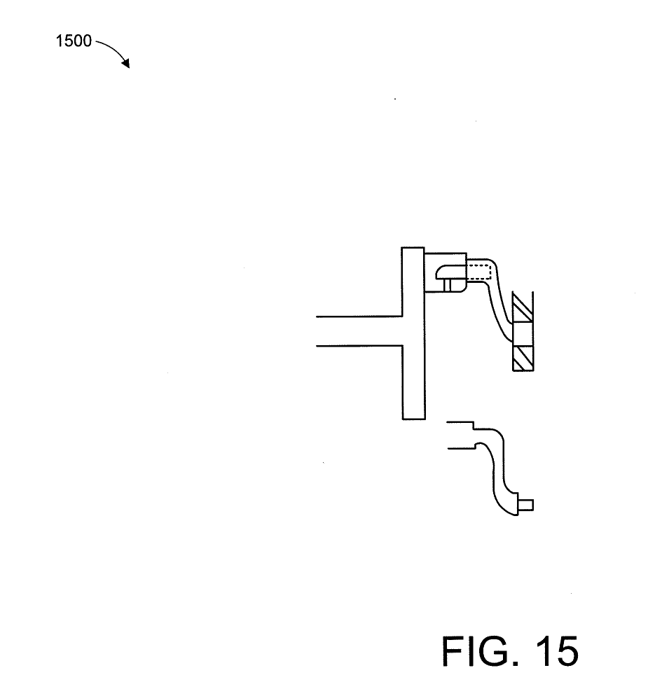

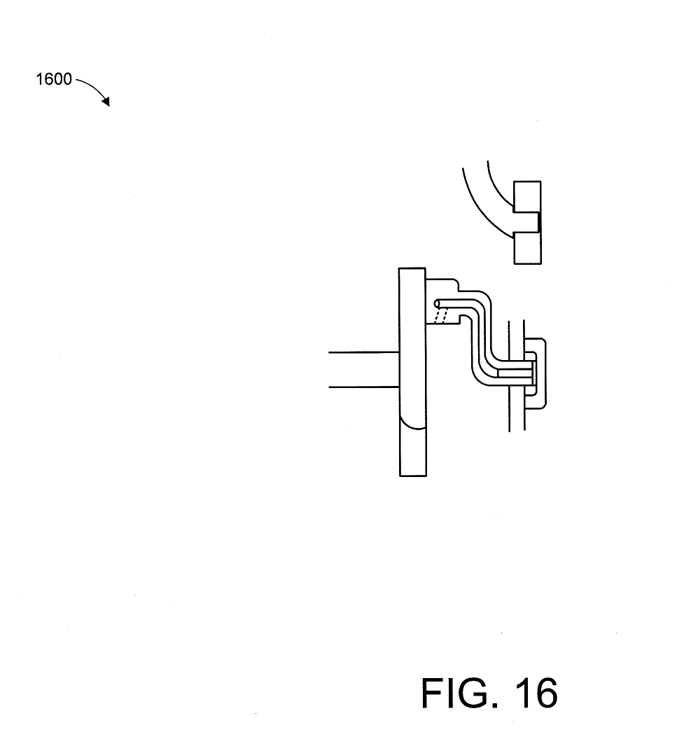

FIG. 15 and FIG. 16 show additional diagrams 1500 and 1600 illustrating additional features. An approach consistent with an implementation can include extending a relatively small extension of the crankshaft from the side away from the power take off of the crank. Since the side away from the power take off needs only to support bending loads put in by the connecting rod, it can be less robust without a significant loss of functionality. If the size and shape of this side is optimized, it can allow the connecting rod bearing to be threaded over that end of the crank, allowing the use of a one piece rod for either plane bearings in the most aggressive case or roller bearings in a more relaxed case. The rollers can cause the clearance between the rod and the crank to be large as it is threaded into place. A snap ring or other retainer can be used to ensure the rollers remain in place during operation. The snap ring or other retainer can be snapped inside the rod or on the outside of the crank.

In some implementations of the above-described feature, a cast or forged steel crank can be used so that the bearing surfaces could be hardened enough to support rollers. Cast iron can be sufficient for plane bearings.

### Improved Ports

In another implementation, an intake and exhaust port geometry for annular sleeve valve engines is provided. 360° annular inlet and exhaust ports can give high efficiency airflow to sleeve valve engines, for example those having one or more features in common with the engines 200 and 300 shown in FIG. 2 and FIG. 3, respectively. A challenge in designing an intake configuration can arise in that air or a mixture of fuel and air is supplied from a round pipe and must be distributed from the single round pipe inlet to a 360° cylindrical annular entrance along the cylinder wall. High flow efficiency can be achieved by having flow directed normal to the annular entrance (radial flow, relative to the cylindrical annulus) and avoiding tangential flow. For outflow from an annular port, radial flow can also be desirable. In at least some instances, outflow must be collected in a manner to deliver it to a single pipe outlet. For certain sleeve valve engines, the flow area can be defined by the sleeve's location relative to the port. The sleeve can have an angled seat, the angle of which can affect the flow efficiency. Flow efficiency can be defined by discharge coefficient, which is the ratio of actual flow to ideal flow through a reference area, as described later in this document.

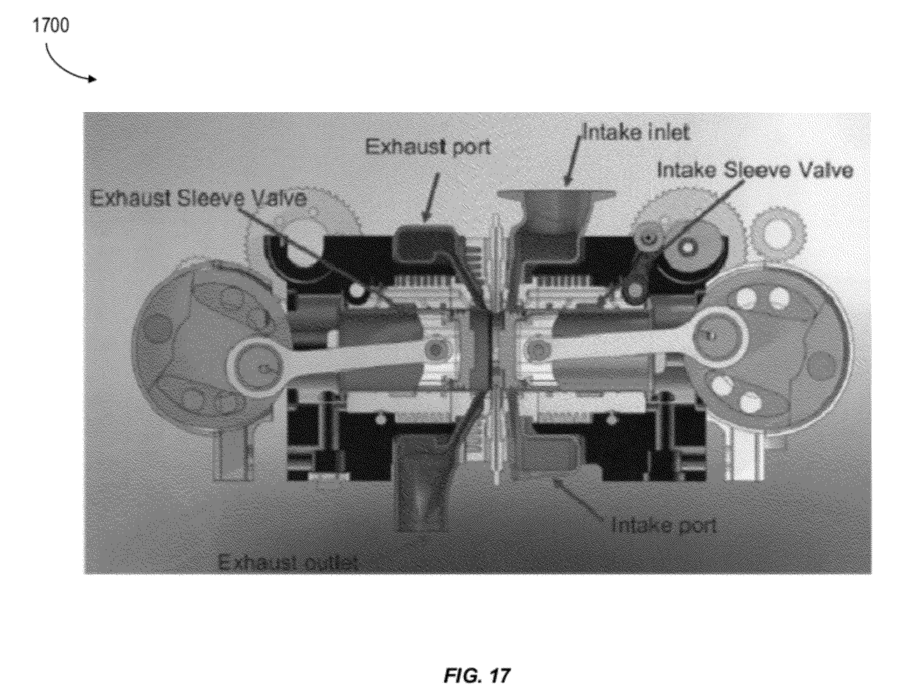

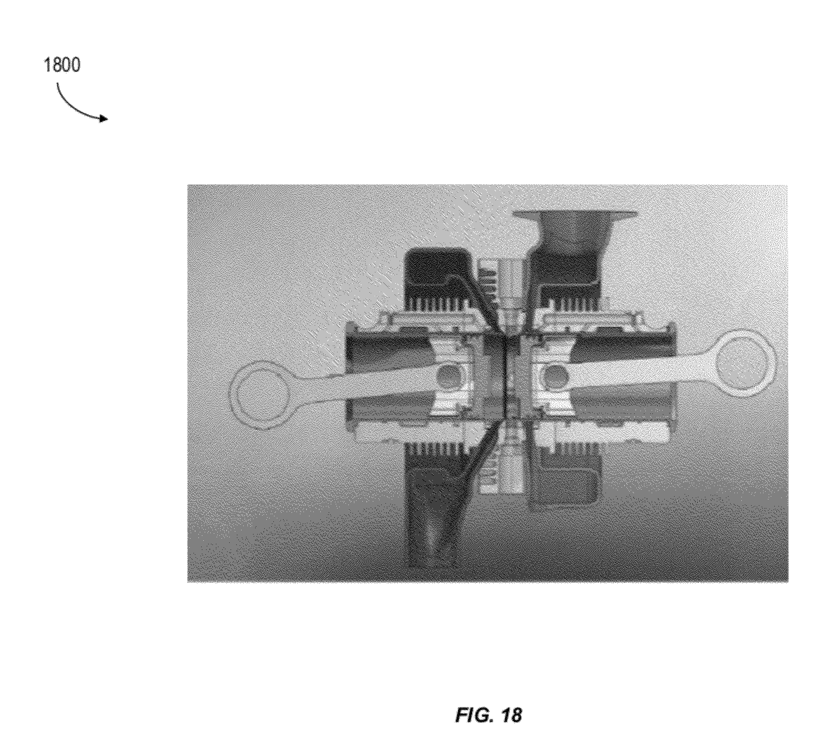

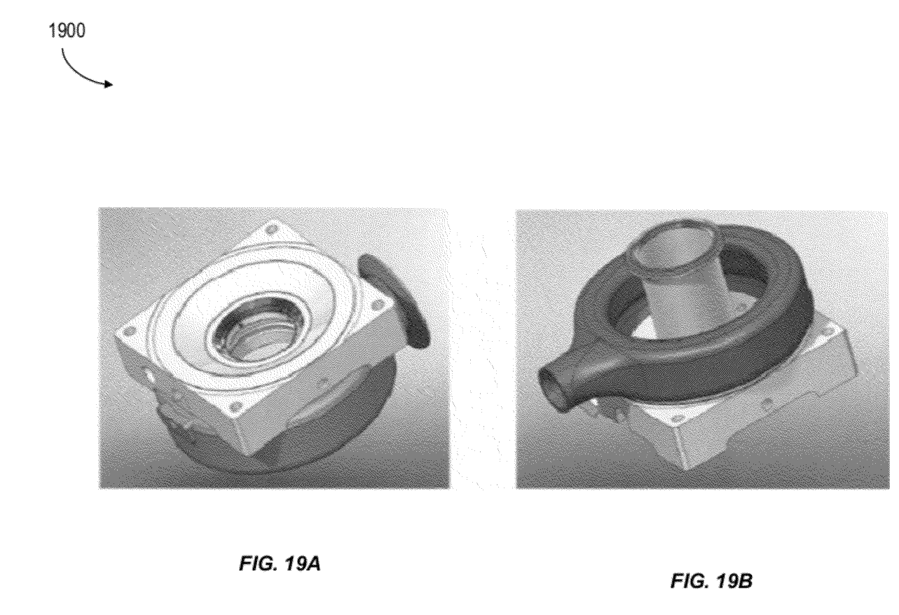

FIG. 17 shows a cutaway view of an example 1700 engine with annular ports. This example engine 1700 is an opposed piston sleeve valve engine. The right side shows an example intake port, and the left shows an example exhaust port. Both ports include features and concepts consistent with the current subject matter. In this example, the ports are exposed as a mechanism moves the sleeve valves away from the seat at the center section of the engine. FIG. 18 shows a cutaway view 1800 of an engine with many components not relevant to the intake and exhaust process removed. FIG. 19A and FIG. 19B show complete 3d views 1900 of the intake and exhaust ports.

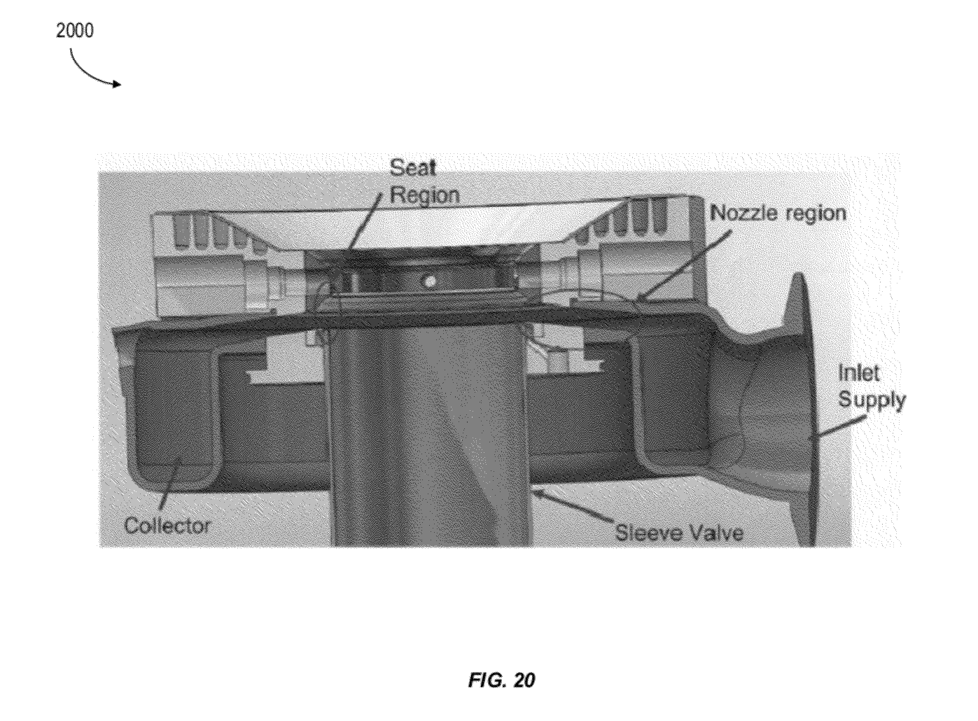

FIG. 20 shows a descriptive cutaway view 2000 of the intake port. When the port is open to the combustion chamber, piston motion increases cylinder volume during the intake stroke and creates a suction, which draws air into the port and subsequently into the engine. The air (or air mixed with fuel) is supplied through a single inlet pipe, and this inlet pipe directs the flow towards the interior vertical wall of the collector. Directing the flow at the wall aids in distributing flow around the collector volume, and flow is intentionally not directed at the nozzle (flow from the intake pipe directly flowing into the nozzle creates tangential velocities). The collector volume and cross sectional area is large enough to keep flow velocities low throughout the collector. The collector accesses the nozzle annularly through the top of the collector. Flow from the collector tends to flow into the nozzle from the collector and enter the cylinder with radial direction dominant. The top and bottom walls of the nozzle section can advantageously be as close to parallel as possible, and oriented as close to normal to axis of the cylinder as possible.

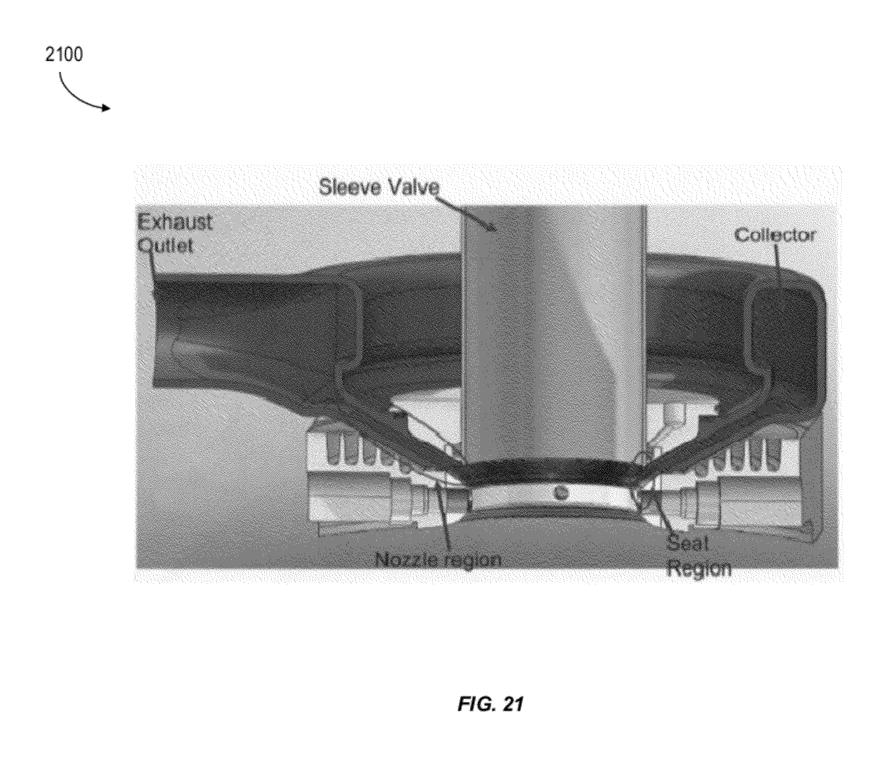

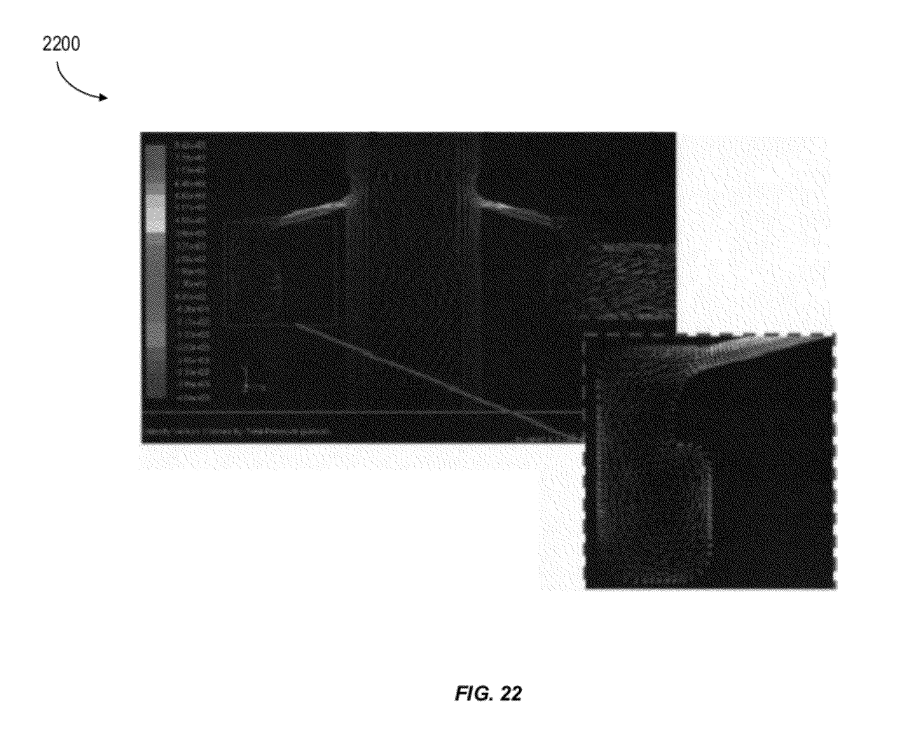

FIG. 21 shows a descriptive cutaway view 2100 of the exhaust port. Piston motion decreases cylinder volume during the exhaust stroke, and forces flow out of the cylinder into the exhaust port. In this example, flow tends to leave the cylinder and enter the nozzle section in a radial manner. Flow leaving the nozzle section enters the collector. Flow entering the collector from the nozzle section tends to circulate in the collector volume around an axis tangential to the collector annulus. This recirculation can in some cases tend to impede outflow if/when the circulating fluid returns to the nozzle-collector interface. In this port design, a step feature can be added to prevent circulation from impeding outflow from the nozzle by redirecting the circulating fluid before it reaches the nozzle-collector interface. FIG. 22 shows a chart 2200 of velocity vectors for the center plane of the exhaust port, and a detail view of the collector region demonstrating the effect of the step to keep recirculation from the nozzle exit. The collector delivers the flow from the collector section to a single outlet pipe. The nozzle for the outflow port can advantageously have near parallel planar top and bottom walls. These walls should be as close to normal to the cylinder axis as possible, but some slanting of the walls is acceptable, if needed for other features of the engine geometry.

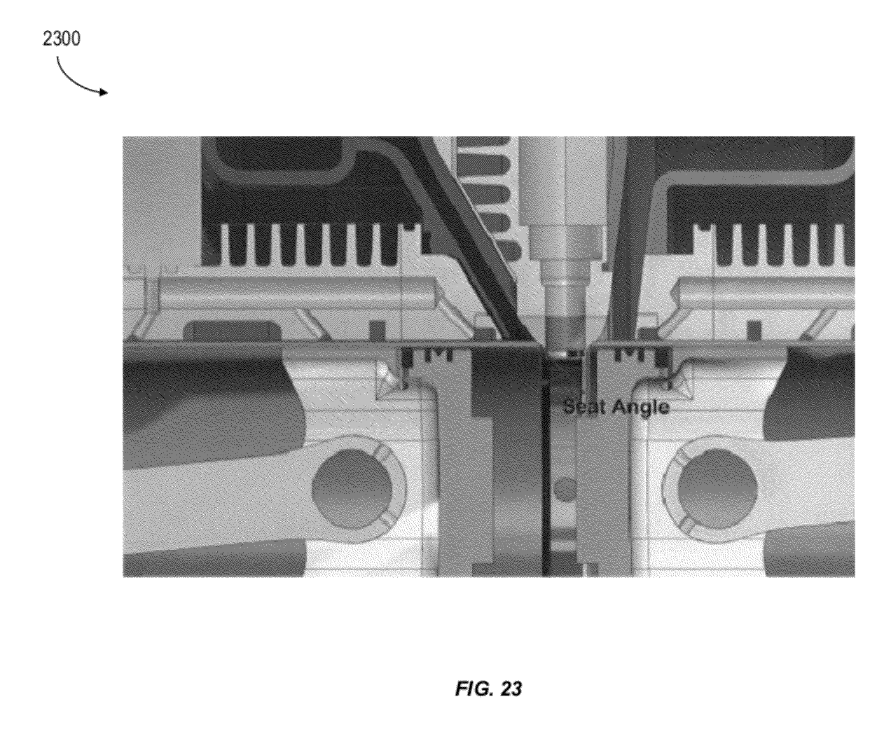

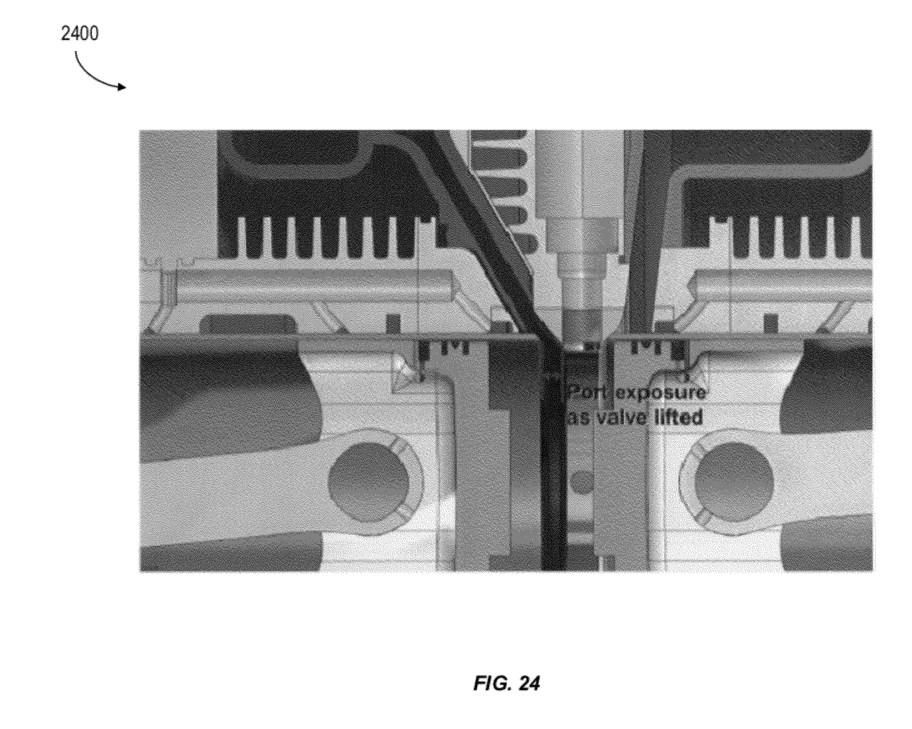

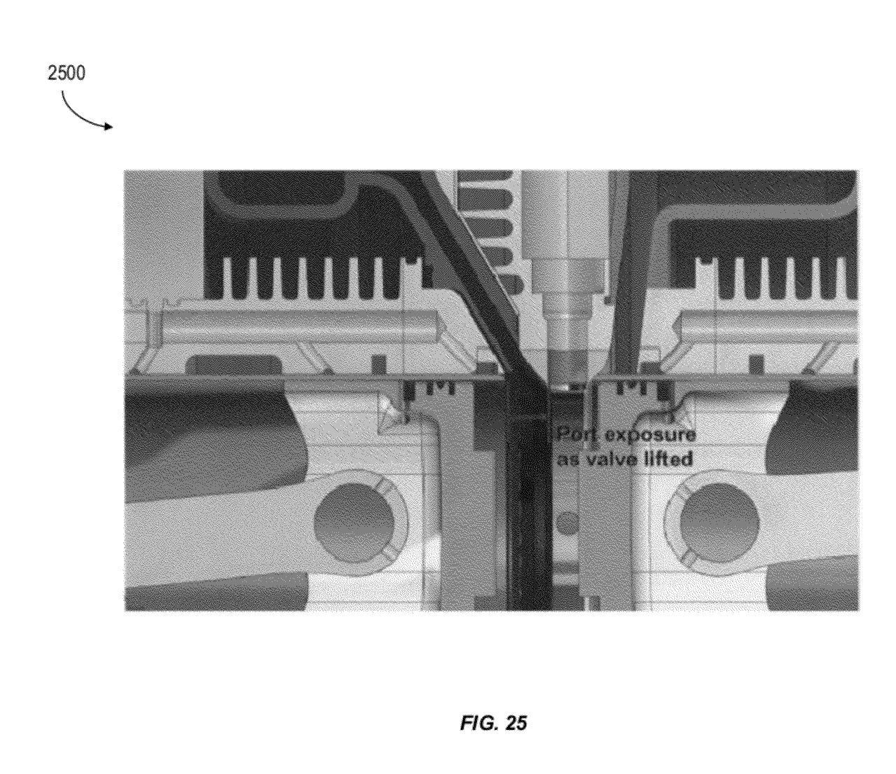

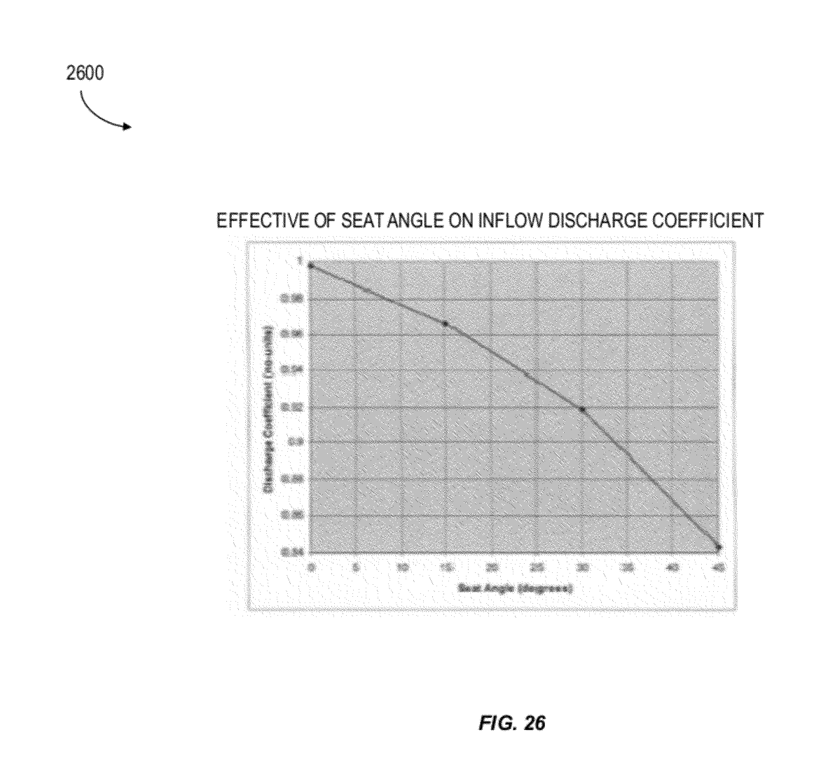

For annular seated sleeve valve engines, a cylindrical sleeve with an angled tip that seats on an angled seat can be included, as shown in the cutaway view in FIG. 23, with the seat angle labeled. FIG. 23 shows a blowup 2300 of the sleeve at its closed (seated) position, FIG. 24 shows a view 2400 of the exhaust sleeve at intermediate lift, and FIG. 25 shows a view 2500 of the exhaust sleeve at maximum lift for this operation condition. Discharge coefficient, a common measure of fluid flow performance, is generally defined as the ratio of actual flow through a port to the ideal flow through an equivalent reference area under fixed conditions. For FIG. 26, which shows a chart 2600 of the effect of the seat angle on the discharge coefficient, the discharge coefficient is defined using the cylindrical cross-sectional area of the port with the sleeve at maximum lift as the reference area, and a pressure gradient of 28 inches of water across the port. FIG. 26 demonstrates the effect of seat angle on discharge coefficient, with a lower seat angle yielding higher discharge coefficients. While small seat angles benefit flow, mechanical and seating force considerations may benefit from larger seat angles.

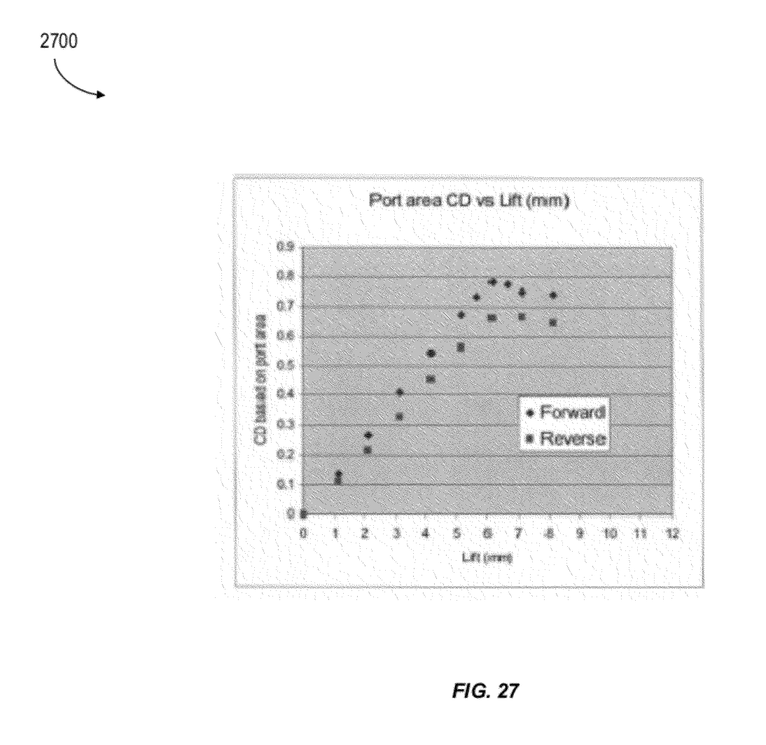

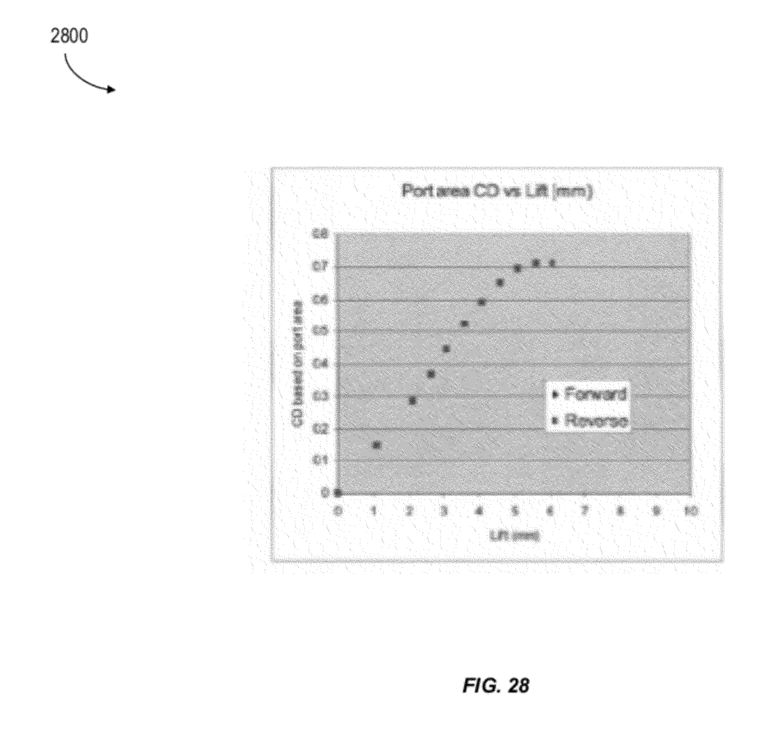

As an example of expected performance for these types of ports, FIG. 27 shows a chart 2700 of discharge coefficient versus sleeve valve lift for the intake port, showing both forward and reverse (backflow out of the port) discharge coefficients. FIG. 28 shows a chart 2800 of reverse (outflow) discharge coefficient for the exhaust port versus lift.

An engine consistent with this implementation can include several beneficial features. Flow through the nozzle+cylinder interface can advantageously have a predominant radial direction. A minimal tangential component of this flow can also be is desirable. Radial flow as used herein generally means flow directed towards the center axis of the engine cylinder and tangential flow as used herein generally means flow tangential to the axis of the cylinder.

The upper and lower surfaces of the nozzle section can advantageously be parallel to within +/− approximately 10°, and the surfaces can advantageously be as close to normal to the cylinder axis as possible within the constraints of the design.

A single inlet pipe for an inlet port can be arranged so that flow does not tend to flow directly into the nozzle section, because direct flow into the nozzle section can tend to establish some tangential flow. It can therefore be advantageous to direct flow into the collector, possibly at a wall so that flow can be distributed tangentially in the collector before entering nozzle section.

For outflow, a recirculation trap in the collector can be helpful in avoiding having the recirculating flow in the collector impede the flow out of the nozzle section. Radial outflow from the nozzle section can tend to recirculate in the collector. A recirculation trap can help mitigate this recirculation reaching the nozzle collector interface.

Flow can improve as the valve seat angle decreases, so a small valve seat angle can be advantageous. However seat angle can also help center and seat the valve, so there is a compromise between valve seat angle for flow and valve seat angle for centering.

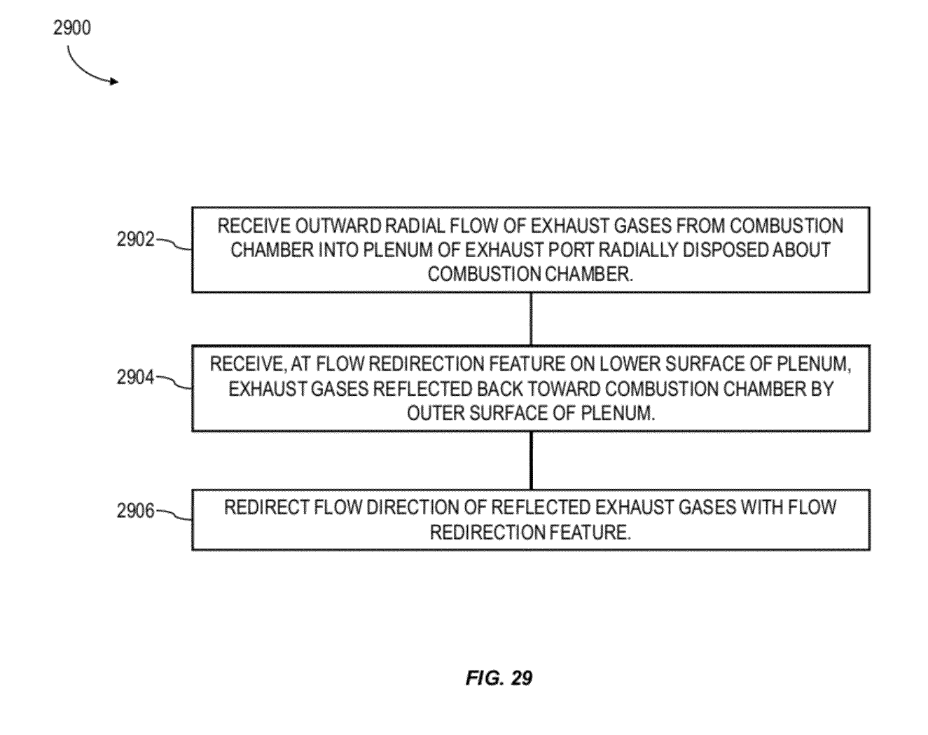

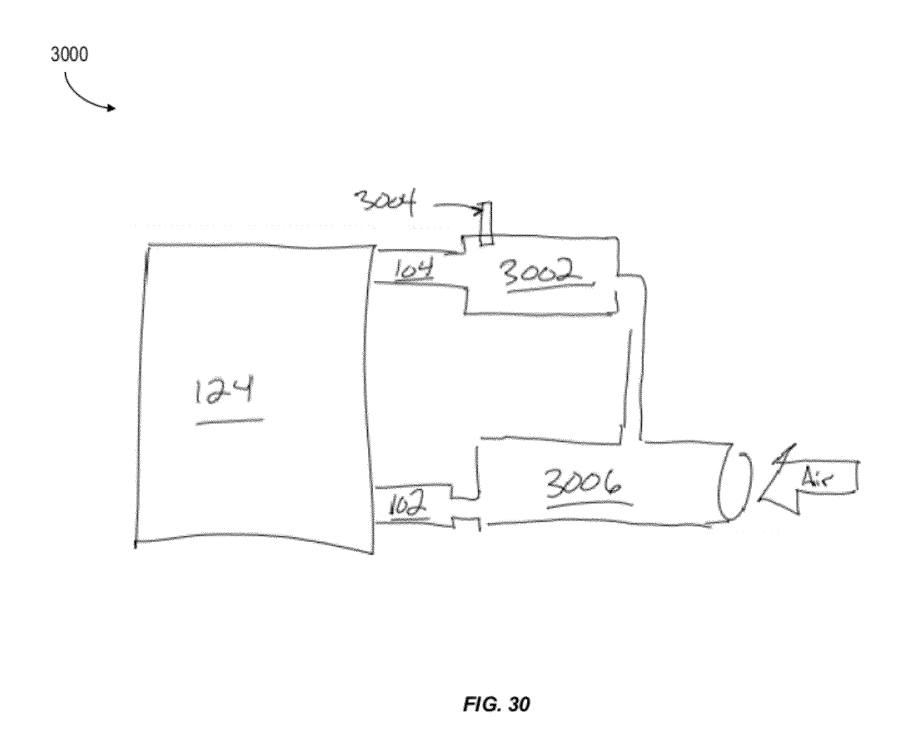

FIG. 29 shows a process flow chart 2900 illustrating features of a method, at least some of which are consistent with implementations of the current subject matter. At 2902, outward radial flow of exhaust gases from a combustion chamber is received into a plenum of an exhaust port that is radially disposed about a combustion chamber of an engine. At 2904, exhaust gases reflected back toward the combustion chamber by an outer surface of the plenum are received at the flow redirection feature on lower surface of plenum. At 2906, the flow direction of the reflected exhaust gases is redirect with the flow redirection feature to enable continued flow out of the combustion chamber without interference from the reflected exhaust gases.

Premixing of Fuel with Exhaust

In another implementation that can be used instead of or in addition to the injection of water into the combustion chamber 124 as discussed above, recycled exhaust gases from a previous engine cycle can be used to precondition fuel engines to ensure proper ignition timing. This approach can be useful in HCCI engines and possible in other engine configurations as well. Exhaust gas reuse can be accomplished by timing the opening and closing of intake and exhaust valves to trap exhaust gas in the combustion chamber so that fuel can be directly injected into the trapped exhaust. However, this approach can result in disruptions to proper airflow through the engine.

Consistent with one or more implementations, hot exhaust generated by combustion of a mixture including air and fuel can be diverted from an exhaust port 104 exiting the combustion chamber 124 to an exhaust gas recirculation manifold 3002 where fuel is added, for example by a fuel port 3004 and mixed with the exhaust gas. In this manner, chemical reactions initiated by fuel exhaust chemistry can commence before the reactants are introduced into the combustion chamber 124. The pre-mixed combination of exhaust gases and fuel can then be introduced into an intake manifold 3006, where it can be mixed with air and then pulled into the combustion chamber 124.

Additionally, or more of the temperature experienced by the pre-mixed combination of exhaust gases and fuel, the amount of fuel mixed with the exhaust gases, the dwell time the fuel-exhaust gas mixture experiences before delivery to the combustion chamber 124, and the amount of the pre-mixed combination of exhaust gases and fuel delivered to each combustion chamber 124 of a multi-cylinder engine can be controlled and/or varied as necessary for a current throttle setting, engine temperature, load, or the like. One or more control valves capable of modulating flow of the fuel-exhaust gas mixture to the each cylinder can allow cylinder by cylinder tuning for controllable HCCI operation across the engine and a desirable operating regime.

In a further implementation, water can be added to the fuel-exhaust gas mixture as discussed above. The water and fuel can react in the exhaust gases to form methyl radicals (CH_{X}), carbon monoxide (CO), hydrogen (H₂), and reactive species that can contribute to combustion of the fuel upon it injection into the combustion chamber. These species can enhance the flammability of the mixture, and the presence of diatomic species such as CO and H₂ can enhance the ability of the exhaust gases to absorb energy for recovery in the power stroke of the engine. Water can optionally be recovered from the exhaust stream by cooling (e.g. using a condensation system 810 as shown in FIG. 8 to generate liquid water from at least some of the water vapor in exhaust gases vented from the combustion chamber 124. Alternatively or in addition, water for injection to the exhaust gas recirculation manifold 3002 and/or the intake manifold 3006 can be supplied from an auxiliary tank (e.g. carried on a vehicle in addition to a fuel tank).

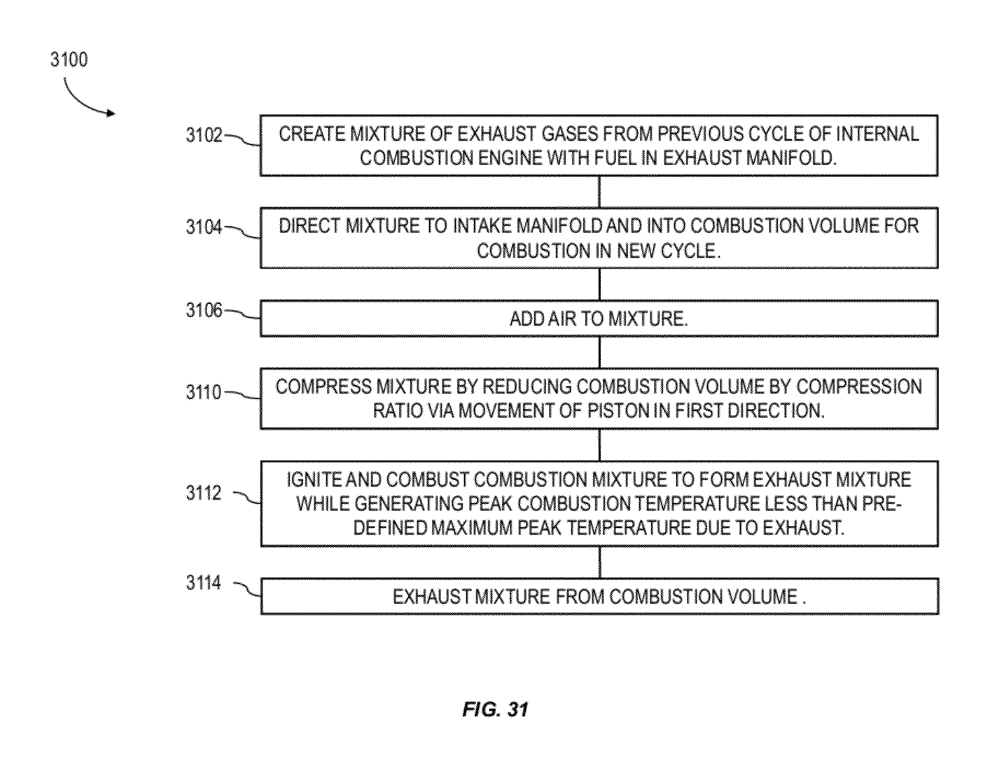

FIG. 31 shows a process flow chart 3100 illustrating features of a method, at least some of which are consistent with implementations of the current subject matter. At 3102, a mixture of exhaust gases from a previous cycle of an internal combustion engine with fuel in an exhaust manifold is created, and at 3104, the mixture is directed to an intake manifold of the internal combustion engine and into a combustion volume for combustion in a new cycle. Air is added to the mixture at 3106 (either in the intake manifold or in the chamber). At 3110, the mixture is compressed, at least in part by reducing the combustion volume by a compression ratio via movement of a piston in a first direction. The combustion mixture is ignited and combusted at 3112 to form an exhaust mixture that includes water vapor and other combustion products. The combusting generates a peak combustion temperature inside the combustion volume that is less than a pre-defined maximum peak temperature due to the amount of exhaust. The combusting includes expanding the combustion volume by an expansion ratio via movement of the piston in a second direction opposite to the first direction. The exhaust mixture is exhausted from the combustion volume at 3114.

### Delayed Ignition Timing.

In a first implementation, an internal combustion engine can be operated with delayed or retarded ignition timing. Use of a variable compression ratio in combination with variable valve timing can optimize the efficiency of an engine at different power levels. However, due to the forces involved, a variable compression mechanism can be complex and expensive. For example, high peak cylinder pressure near top dead center can produce low torque because the crankshaft lever arm is very small when these forces are high. Ring friction can be high when the gas pressure is high and the rings are moving in the boundary lubrication regime instead of the hydrodynamic regime.

Fuel-air mixtures can be cycled through high temperature and pressure conditions without auto ignition. However, when such a mixture is burned in a combustion chamber, the last gases to burn, which have been subjected to even higher pressures and temperatures for a longer time, can tend to ignite all at once in a manner more closely resembling an explosion than an orderly consumption of fuel by an the advancing flame front. Explosive detonation of pockets of fuel in this manner can cause severe engine damage.

The compression ratio of the engine is generally limited by the octane rating of the fuel being used and the combustion chamber design. In general, an engine is designed with as high a compression ratio as can be achieved without causing fuel auto-ignition at a peak chamber pressure within a few degrees of a top dead center piston position. A typical compression ratio for gasoline engines can be on the order of approximately 10:1.

If an engine is designed for a compression ratio of, for example, 15:1, and the spark is delayed until the piston is past top dead center near a chamber volume that is close to a compression of 10:1, then the auto-ignition properties can be similar to a more typical lower compression case. However, the piston in the delayed ignition example is well past the physical top dead center position, and the leverage on the crankshaft can be improved significantly. In addition, because the piston is already moving down the bore at a velocity that can likely have the rings up to a velocity high enough to be hydrodynamic, when the high peak pressures of combustion occur, the ring friction can be reduced compared to the conventional approach. Furthermore, because the piston is already moving in the direction of expansion as the ignition event occurs, knock resistance of the end gas can also be improved as the combustion chamber volume increases during combustion such that the pressure and temperature decrease before completion of combustion is reduced. Some of this advantage can be offset by chemical changes that may occur to the fuel during the initial over-compression phase, thereby increasing the likelihood of auto ignition. One or more approaches such as those described in co-owned and co-pending international patent application no. PCT/US2011/027775, the disclosure of which is incorporated by reference in its entirety, may optionally be applied to minimize the integral of time and heat transfer to the fuel that occurs prior to the desired combustion event.

Using one or more features consistent with the approach described herein, an engine with an effective 10:1 compression ratio and 10:1 expansion ratio at normal valve timings can, with valve timings that limit the mass flow, be operated with a 10:1 compression ratio and a 15:1 expansion ratio. The ignition timing can be advanced to more normal conditions to achieve this effect.

Implementations of the current aspect can also be incorporated into phase shift variable compression ratio designs. In an opposed piston engine in which two pistons share a cylinder and the two pistons are not in phase, for example with a first, leading piston reaching top dead center prior to a second, trailing piston, it can be desirable to ignite the air-fuel mixture when the trailing piston is near top dead center. Because the leading piston is already moving away from the top dead center position as the trailing piston reaches top dead center, ignition occurs after the minimum volume of the combustion chamber has been reached and the volume of the combustion chamber has begun to increase. The air-fuel mixture can have undergone an over-compression and partial expansion before firing when the trailing piston is near top dead center.

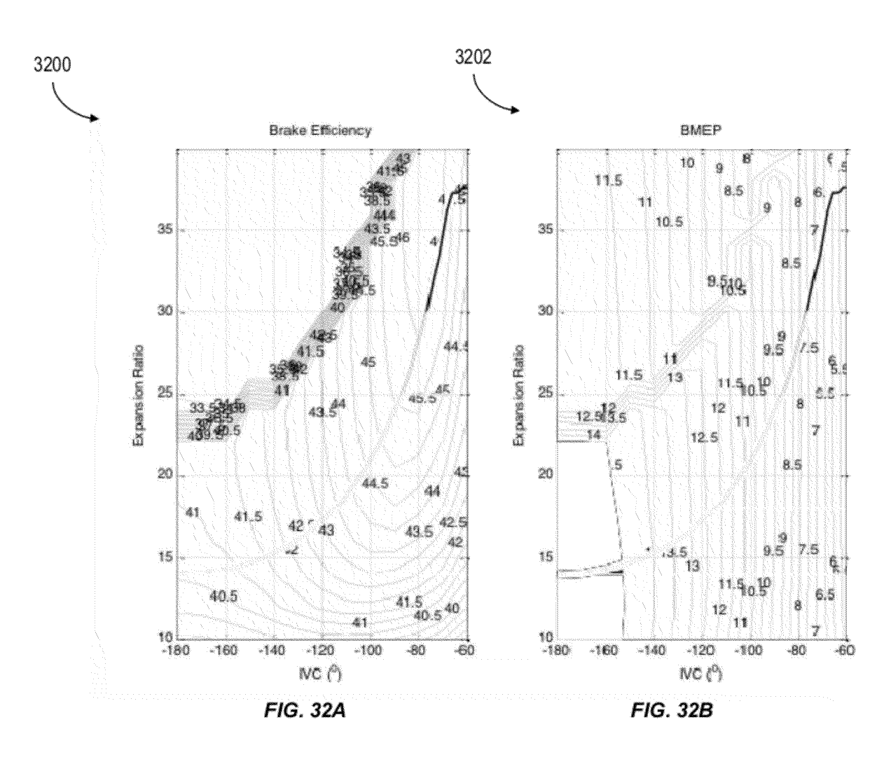

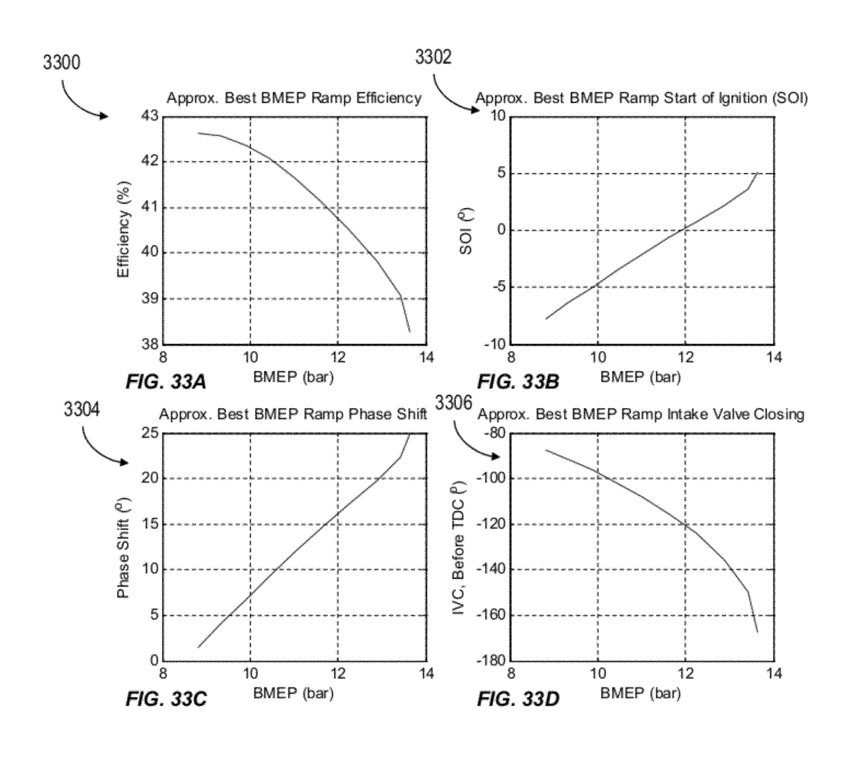

The charts 3200 and 3202 of brake efficiency and brake mean effective pressure (BMEP) as functions of the expansion ratio (y-axes) and intake valve closing (IVC) shown in FIG. 32A and FIG. 32B, respectively, show an approximately 1% efficiency benefit of operating an engine symmetrically in a 14:1 ratio of the compression ratio (CR) to the expansion ratio (ER) vs. a more conventional symmetric 10:1 ratio at the same BMEP. This region is in the lower left corner of each graph.

Benefits from an approach consistent with features described herein for a fixed geometry engine can be realized from reduced friction due to the ring velocity when the pressure is high as well as improved torque due to a more advantageous rod angle when ignition occurs. The charts 3200, 3302, 3304, and 3306 in FIG. 33A, FIG. 33B, FIG. 33C, and FIG. 33D respectively show relationships between approximate best BMEP ramp efficiency, approximate best BMEP ramp at start of ignition (SOI), approximate best BMEP ramp phase shift, and approximate best BMEP ramp at intake valve closing illustrate possible advantages of implementations that include one or more of the features described herein. In an opposed piston engine, additional benefits can include the ability to time the ignition when the trailing piston is at top dead center and the leading piston has already reached top dead center and begun to retract. This configuration can provide additional benefits in limiting the torque reversals on the power transmission between cranks as well as in limiting the amount of power into the trailing crank thereby reducing losses due to the power transmission into the leading crank. Additional benefits for an engine with variable valve timing can include the ability to obtain higher mass flow at a reduced expansion ratio to enable higher power output (high power density). The same torque reversal and loss issues apply as for the opposed piston engine. Benefits for a fully variable engine can be similar to a fixed engine. Heat losses can also be improved using an approach such as is described herein. The dwell time at the peak temperatures and pressures is reduced. The piston is moving down at a faster rate at peak pressure and temperature conditions, so at the same crankshaft speed, the time at the peak pressure will be reduced.

### Fuel Preheating for Diesel Engines

In another implementation, a heated diesel injector is provided. Diesel fuel droplets can evaporate sufficiently slowly during combustion that the fuel molecules that evaporate from the liquid phase later in the combustion process can in some cases have already undergone one or more chemical changes before burning. Such changes can potentially result in particulate matter formation from poor or incomplete oxidation of these chemical changed residual compounds. Additionally, the speed of burning of the fuel can at least in part be limited by the rate at which the fuel evaporates. Faster evaporation can lead to faster burning, which can lead to better efficiency.

In implementations of the current subject matter, fuel can be heated prior to being injected into the combustion chamber. By adding sufficient thermal energy to the liquid fuel prior to its delivery into the combustion chamber, the liquid can already be above the boiling point of the fuel at the combustion chamber pressure when it enters the combustion chamber. Because the injection pressure can be well above the chamber pressure and the heat can be added while the fuel is at this high pressure, the fuel can remain in the liquid phase prior to delivery to the combustion chamber.

To limit the progress of potentially undesirable chemical reactions that the liquid fuel may undergo at elevated temperatures, it can be desirable to minimize a residence time of the fuel in a heated zone of the injector assembly. To ensure sufficient energy transfer to elevate the fuel temperature to a desired point despite a short contact time, very high instantaneous power delivery to the fuel can be required.

In some implementations, heating energy can be delivered to the liquid fuel in the injector system via electrical resistance heating. For example, the injector nozzle region can include one or more built-in electrical insulating regions such that at least two or more electrodes can be electrically isolated from one another. These electrodes can be in close proximity to the injector nozzle such that the fuel loses very little heat in its travel from the heating zone and delivery to the combustion chamber. The electrodes can be connected to a power source that can in some instances be switched on just before or at the time of injection such that only the fuel being injected is heated to these high temperatures. The heating electrodes can be switched off again at the end of injection. The resistor used to turn the electrical energy into heat can be a traditional metal or semiconductor resistor, the fuel itself, or some other device or approach for converting electricity into heat.

In one implementation, a pintle of a diesel injector of a diesel engine can serve as a first electrode and an injection orifice or nozzle of the diesel injector can serve as a second electrode. Electrical energy can be supplied as the pintle is lifted off its seat. The electrical path can then be from the pintle, through the fuel, and to the nozzle. Such an approach can advantageously heat only fuel in use and has no problems with hot fuel remaining in the system after shut down, or on transitions from high power to zero power as in a gearshift.

A technique of heating the fuel as it is injected is not limited to diesel applications, but is also appropriate for low boiling point fuels in a port injection application or for cold starting with normal fuels. The approach can also be advantageous for spark ignition direct injection. This technique can also be used for injecting fuels other than diesel into a compression ignition cycle.

### Two Stroke Asymmetrical Engine

In another implementation, a two-stroke asymmetric engine is provided. Conventional two-stroke engines typically have only a single piston in a cylinder and have ports to allow exhaust gases out and fresh air in. Since both ports are controlled by the single piston, the exhaust port has to open first and close last, allowing excess fresh air to flow out the exhaust. Additionally they are limited to symmetric compression and expansion strokes.

Opposed piston engines can allow the exhaust port to be controlled by one piston and the intake port controlled by the other piston. Typically these engines have slightly out of phase crankshafts so that the exhaust port opens first allowing the high pressure hot gasses to blow down into the exhaust pipe and impart momentum into the exhaust gas column. The intake port can then open to the reduced pressure in the cylinder and be able to purge the exhaust with the fresh charge. Historically, such engines have been diesel so that over-purging would not waste unburned fuel into the exhaust.

Such an asymmetric port configuration can be combined with a pull rod actuation method of connecting the second piston to the crank for the purpose of being able to supercharge the cylinder while the exhaust port is closed and the intake is still open.

This new design can in some examples include an opposed piston two stroke in which the crankshaft phasing and the intake and exhaust port heights are adjusted so that the effective compression ratio is smaller than the effective expansion stroke.

In one example, the exhaust port height can be approximately 0.1 inches tall above the piston at bottom dead center, the intake port can be approximately 0.35 inches above the intake piston at bottom dead center, the stroke of each piston can be approximately 2 inches and the phasing of the crankshafts can be such that the exhaust leads the intake crank by approximately 50 degrees. In this approximate example, the exhaust port opens first, then the intake, then the exhaust closes, and then after some fresh charge is pushed back into the intake, the intake port closes. From that point to the minimum volume the change is about 10:1. However, the volume change from minimum to when the exhaust port opens is about 15:1. This configuration can allow for more work to be extracted from the hot gases before they are blown out into the exhaust.

If the expansion is limited to a ratio that maintains the cylinder pressure above approximately 2 times the pressure in the exhaust manifold, the gas can be accelerated to its maximum velocity which imparts momentum into the exhaust gas column. That momentum can then cause the exhaust gas to keep flowing away from the cylinder while the intake port opens. The intake charge can be pulled in by the reduced pressure if the exhaust system is tuned properly. Otherwise, the intake can be forced in by any number of different types of air pumps. (for example a crankcase as in conventional engines, superchargers, turbochargers, vane pumps, and the like).

This engine can have an advantage of having no explicit valve train while still being able to have the high efficiency of the asymmetric compression and expansion stroke. Such an engine can be configured either for diesel combustion or, as discussed above, for spark ignition combustion. To produce the highest efficiency, gasoline direct injection can be used so that only air is used for purging. After the exhaust port is closed, the fuel can be injected. IN this manner, fuel being pushed back into the intake manifold may not be a problem because this fuel would merely be brought back in on the next cycle. The fuel flow rate can be based on the net air flow in, so the next injection can be sized to account for the fuel already in the air. If problems arise with some of that fuel exiting the exhaust unburned, the injection can be timed later so that there would be no fuel in the air pushed back into the intake manifold.

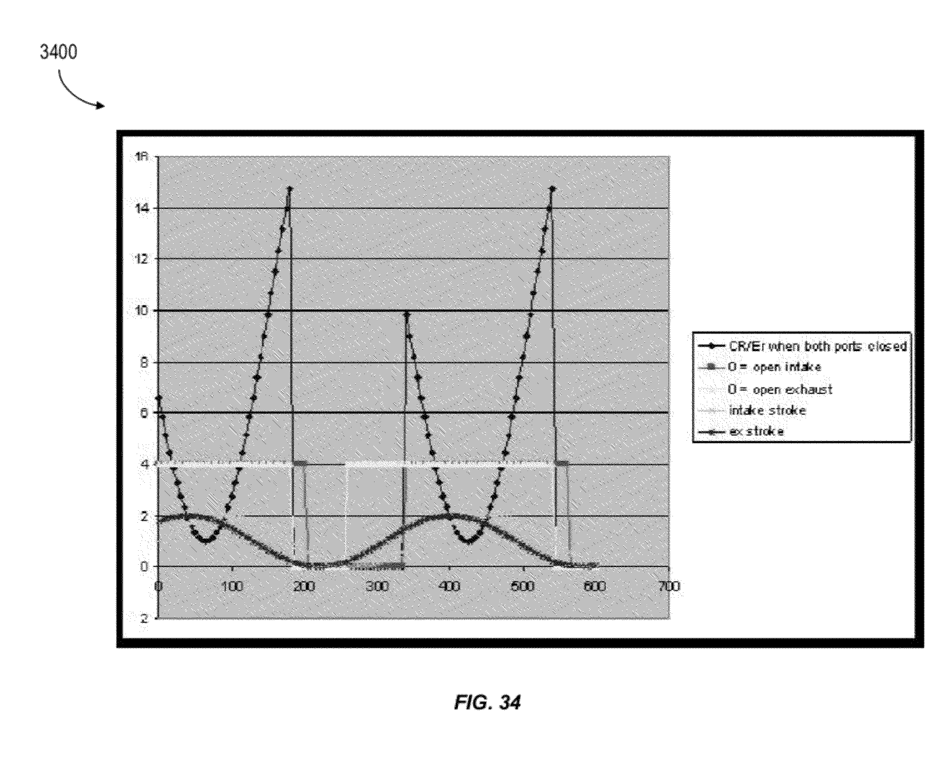

As shown in the chart 3400 of FIG. 34, the compression ratio the charge sees can be the one when the intake port closes, the expansion ratio it saw is the ratio just as the exhaust port opens.

This opposed piston methodology also allows the use of the same optimized bore/stroke ratio as for a low heat loss design. The optimum ratio can differ from a four-stroke engine with the same general size because so much of the piston travel occurs while ports are open. The friction characteristics can also differ because there is no valve train friction. However, explicit pumping can be required. The pistons also travel an extra distance past the ports. A lower power density than the supercharged version mentioned above can be used. Such a configuration can provide the advantage of asymmetry. Additionally, the bore/stroke ratio can be optimized to obtain even lower heat losses.

A configuration such as described herein can also allow a simplified design for causing the cylinder to rotate while the pistons run inside. This would allow for designing the relative speeds to be such that the piston rings could be kept riding up on an oil film even during piston direction reversals.

Using a sleeve valves as the intake, for example as shown in FIG. 20, can shorten the purge path length and allow shorter ports and thereby more cylinder filling and power for each stroke. The sleeve valve can be actuated every cycle and used in the same manner as the intake port discussed above: opening after the exhaust ports open and the exhaust pressure has blown down and remaining open long enough such that some of the intake air is pushed back into the intake tract. The sleeve valve can close to give the desired compression ratio that would typically be less than the expansion ratio.

The added benefit of such a configuration is that now two exhaust ports can be used to increase the area available at blowdown. Also with this configuration, there is no longer a need to have the crankshafts out of phase. The timing of the intake flow need not be dependent on the crank position, thereby allowing variable valve timing that could also go along with variable compression.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

1. A system comprising:
a tubular conduit for conducting exhaust gases from an exhaust gas source, the tubular conduit comprising a conduit cross sectional flow area approximately perpendicular to a direction of exhaust gas flow within the tubular conduit;
a plurality of passages positioned within a section of the tubular conduit, each of the plurality of passages having a passage length and a passage cross sectional flow area, the passage length and passage cross sectional area of each of the plurality of passages being paired to create an approximately equal flow rate for exhaust gases flowing through the tubular conduit; and
a collector chamber positioned downstream of the plurality of passages to receive the exhaust gases exiting the plurality of passages, the collector chamber having a sufficiently large collector chamber volume such that the exhaust gases within the collector volume present an approximately equivalent pressure across an exit face of each of the plurality of passages.

2. A system as in claim 1, further comprising a plurality of second passages positioned within a second section of the tubular conduit downstream of the collector chamber, each of the plurality of second passages having a second passage length and a second passage cross sectional flow area, the second passage length and second passage cross sectional area of each of the plurality of second passages being paired to create a second approximately equal flow rate across the tubular conduit for exhaust gases flowing through the second plurality of passages.

3. A system as in claim 1, wherein at least part of an interior surface area of one or more of the plurality of passages comprises a coating comprising a catalyst material.

4. A system as in claim 1, wherein the catalyst coating catalyzes at least one reaction that converts at least one combustion by-product present in the exhaust gases to at least one target compound.

5. A system as in claim 1, wherein the at least part of an interior surface area of one or more of the plurality of passages comprises a surface roughening treatment that provides increased surface area relative to an untreated surface.

6. A system as in claim 1, wherein the plurality of passages comprise a piece of sheet metal rolled to fit within the conduit cross sectional flow area, the piece of sheet metal comprising a plurality of corrugations of differing lengths that form the plurality of passages when the piece of sheet metal is rolled to fit within the conduit cross sectional flow area.

7. A system as in claim 6, wherein the piece of sheet metal has an approximately triangular shape that comprises a first edge, a second edge, and a third edge, wherein an axis of each the plurality of corrugations is aligned approximately parallel to the first edge, and wherein the piece of sheet metal is rolled along a rolling axis that is at least approximately perpendicular to the first edge.

8. A method comprising:
conducting exhaust gases from an exhaust gas source through a tubular conduit comprising a conduit cross sectional flow area approximately perpendicular to a direction of exhaust gas flow within the tubular conduit;
causing the exhaust gases to flow through a plurality of passages positioned within a section of the tubular conduit, each of the plurality of passages having a passage length and a passage cross sectional flow area, the passage length and passage cross sectional area of each of the plurality of passages being paired to create an approximately equal flow per unit cross section area for the exhaust gases flowing through each of the plurality of passages; and
receiving the exhaust gases in a collector chamber positioned downstream of the plurality of passages, the collector chamber having a sufficiently large collector chamber volume such that the exhaust gases within the collector volume present an approximately equivalent pressure across an exit face of each of the plurality of passages.

9. A method as in claim 8, further comprising also causing the exhaust gases to flow through a plurality of second passages positioned within a second section of the tubular conduit downstream of the collector chamber, each of the plurality of second passages having a second passage length and a second passage cross sectional flow area, the second passage length and second passage cross sectional area of each of the plurality of second passages being paired to create a second approximately equal flow rate across the exit of the plurality of passages for exhaust gases flowing through the tubular conduit.

10. A method as in claim 8, further comprising catalyzing a reaction that converts at least one combustion by-product present in the exhaust gases to at least one target compound, the catalyzing comprising contacting the exhaust gases with a catalyst material at least partly coating an interior surface area of one or more of the plurality of passages.

11. A method as in claim 8, wherein the at least part of an interior surface area of one or more of the plurality of passages comprises a surface roughening treatment that provides increased surface area relative to an untreated surface.

12. A method as in claim 8, wherein the plurality of passages comprise a piece of sheet metal rolled to fit within the conduit cross sectional flow area, the piece of sheet metal comprising a plurality of corrugations of differing lengths that form the plurality of passages when the piece of sheet metal is rolled to fit within the conduit cross sectional flow area.

13. A method as in claim 12, wherein the piece of sheet metal has an approximately triangular shape that comprises a first edge, a second edge, and a third edge, wherein an axis of each the plurality of corrugations is aligned approximately parallel to the first edge, and wherein the piece of sheet metal is rolled along a rolling axis that is at least approximately perpendicular to the first edge.

14. A method comprising:
forming an array of passages comprising a plurality of passages having a distribution of passage cross sectional flow areas and passage lengths, the passage length and passage cross sectional area of each of the plurality of passages being paired to create an approximately equal flow rate per unit area for exhaust gases flowing through each of the plurality of passages;
positioning the array of passages such that the array of passages at least partially fills a conduit cross sectional flow area of a tubular conduit for conducting exhaust gases from an exhaust gas source; and
connecting a collector chamber positioned downstream of the array of passages to receive exhaust gases exiting the plurality of passages, the collector chamber having a sufficiently large collector chamber volume such that the exhaust gases within the collector volume present an approximately equivalent pressure across an exit face of each of the plurality of passages.

15. A method as in claim 14, further comprising forming a plurality of second passages positioned within a second section of the tubular conduit downstream of the collector chamber, each of the plurality of second passages having a second passage length and a second passage cross sectional flow area, the second passage length and second passage cross sectional area of each of the plurality of second passages being paired to create a second approximately equal flow rate across the tubular conduit for exhaust gases flowing through the second plurality of passages.

16. A method as in claim 14, further comprising coating at least part of an interior surface area of one or more of the plurality of passages with a coating comprising a catalyst material.

17. A method as in claim 16, wherein the catalyst material catalyzes at least one reaction that converts at least one combustion by-product present in the exhaust gases to at least one target compound.

18. A method as in claim 14, further comprising roughening at least part of an interior surface area of one or more of the plurality of passages, the roughening increasing a roughness of the at least part of the interior surface area relative to an untreated surface of the passage.

19. A method as in claim 18, wherein the roughening comprises applying a surface roughening treatment to the at least part of the interior surface area.

20. A method as in claim 14, wherein the forming of the plurality of passages comprises creating a plurality of corrugations on an approximately triangular piece of sheet metal comprising a first edge, a second edge, and a third edge, the plurality of corrugations being spaced at a distance that is proportional to a distance between the second and third edges and having differing lengths that form the plurality of passages when the piece of sheet metal is rolled along a rolling axis that is at least approximately perpendicular to the first edge to fit within the conduit cross sectional flow area.

21-50. (canceled)
